(19) United States
(12) Patent Application Publication
(10) Pub. No.: US 2026/0091714 A1
(43) Pub. Date: Apr. 2, 2026

(54) CHILD VEHICLE SEAT SYSTEM

(71) Applicant: WONDERLAND SWITZERLAND AG, Steinhausen (CH)

(72) Inventors: KYLE S. MASON, Morgantown, PA (US); David A. LEHMAN, Morgantown, PA (US); Nathaniel W. KEEBLER, Morgantown, PA (US); Leif MALM, Morgantown, PA (US)

(21) Appl. No.: 19/115,365

(22) PCT Filed: Sep. 27, 2023
(86) PCT No.: PCT/US2023/033857

§ 371 Date: Mar. 26, 2025

Related U.S. Application Data
(60) Provisional application No. 63/410,929, filed on Sep. 28, 2022.
(60) Provisional application No. 63/385,444, filed on Nov. 30, 2022.
(60) Provisional application No. 63/484,148, filed on Feb. 9, 2023.
(60) Provisional application No. 63/504,355, filed on May 25, 2023.
(60) Provisional application No. 63/517,463, filed on Aug. 3, 2023.

(51) Int. Cl. B60N 2/28

(52) U.S. Cl. CPC B60N 2/2875; B60N 2/2806; B60N 2/2816; B60N 2/2845; B60N 2/2869; B60N 2/2824; B60N 2/2851

(57) ABSTRACT

A support base for a child restraint system suitable for placement on a vehicle seat is provided. The child restraint system includes an infant child seat and a convertible child seat. The support base includes a base body and a seat receiving assembly. The seat receiving assembly includes an incline member movably mounted to the base body. The incline member is movable along an incline path between a first position and a second position. A seat attachment is rotatably connected to the incline member. The seat attachment is rotatable relative to the incline member between a first rotational configuration and a second rotational configuration.

### CROSS REFERENCE TO RELATED APPLICATIONS

This application claims the benefit of U.S. Application No. 63/410929, filed on Sep. 28, 2022, U.S. Application No. 63/385444, filed on Nov. 30, 2022, U.S. Application No. 63/484148, filed on Feb. 9, 2023, U.S. Application No. 63/504355, filed on May 25, 2023 and U.S. Application No. 63/517463, filed on Aug. 3, 2023, which are incorporated herein by reference in their entirety.

### FIELD

Embodiments of the present disclosure relate to the art of child restraint systems for use in a vehicle, and more particularly to a support base of a child restraint system.

### BACKGROUND

A child restraint system is designed to protect a child from injury or death during a collision of a vehicle. Existing child restraint systems commonly include a base portion and a seat portion detachably installed on the base portion. When a child restraint system is secured on a vehicle by a lower anchor or a vehicle belt, the base portion must be adjusted to a proper reclined angle. In addition, depending on the type of seat that is being used, the seat may be position either in a forward-facing or a rearward-facing orientation. Existing base portions cannot support different type of seats in different orientations and at various angles of recline.

### BRIEF DESCRIPTION

According to an embodiment, a support base for a child restraint system suitable for placement on a vehicle seat is provided. The child restraint system includes an infant child seat and a convertible child seat. The support base includes a base body and a seat receiving assembly. The seat receiving assembly includes an incline member movably mounted to the base body. The incline member is movable along an incline path between a first position and a second position. A seat attachment is rotatably connected to the incline member. The seat attachment is rotatable relative to the incline member between a first rotational configuration and a second rotational configuration.

In addition to one or more of the features described above, or as an alternative, in further embodiments the seat attachment is configured to detachably connect to both the infant child seat and the convertible child seat.

In addition to one or more of the features described above, or as an alternative, in further embodiments the seat attachment is rotatable relative to the incline member at any position of the incline member relative to the incline path.

In addition to one or more of the features described above, or as an alternative, in further embodiments the support base further includes a belt receiving path for a vehicle belt associated with the vehicle seat and an exterior surface of the base body.

In addition to one or more of the features described above, or as an alternative, in further embodiments the support base further includes a belt tensioner mounted to the base body. The belt tensioner being movable to apply a tension to the vehicle belt.

In addition to one or more of the features described above, or as an alternative, in further embodiments the incline member is located remotely from the belt receiving path such that the tension applied to the vehicle belt by the belt tensioner is unaffected by movement of the incline member over the incline path.

In addition to one or more of the features described above, or as an alternative, in further embodiments the base body further includes at least one elongated slot and the incline member is coupled to the at least one elongated slot. The at least one elongated slot defines the incline path of the incline member between the first position and the second position.

In addition to one or more of the features described above, or as an alternative, in further embodiments the base body further includes a seat portion and a back portion. The back portion being arranged at an angle relative to the seat portion.

In addition to one or more of the features described above, or as an alternative, in further embodiments the incline member further includes a first leg and a second leg and each of the first leg and the second leg has an upper portion and a lower portion. The upper portions of the first and second leg are connected by a connecting member.

In addition to one or more of the features described above, or as an alternative, in further embodiments the upper portions are arranged within the back portion and the lower portion is arranged within the seat portion.

In addition to one or more of the features described above, or as an alternative, in further embodiments an angle formed between the upper portion and the lower portion of the first leg and the second leg is equal to the angle formed between the seat portion and the back portion.

In addition to one or more of the features described above, or as an alternative, in further embodiments the incline member further includes a base anchor member connectable to a seat anchor member of at least one of the infant child seat and the convertible child seat.

In addition to one or more of the features described above, or as an alternative, in further embodiments the first rotational configuration is a forward-facing position and the second rotational configuration is a rearward-facing position.

In addition to one or more of the features described above, or as an alternative, in further embodiments the seat attachment further includes a support platform connectable to the infant child seat and the convertible child seat and an attachment member coupled to the support platform. The support platform is in axial overlapping arrangement with the attachment member.

In addition to one or more of the features described above, or as an alternative, in further embodiments the attachment member further includes an opening and the incline member further includes a mounting post. The mounting post is receivable within the opening to define an axis of rotation of the seat attachment.

In addition to one or more of the features described above, or as an alternative, in further embodiments the incline member is movable relative to the base body along the incline path.

According to an embodiment, a support base for a child restraint system suitable for placement on a vehicle seat is provided. The child restraint system includes a child seat and the support base includes a base body and an incline member movably mounted to the base body. The incline member is movable along an incline path between a first position and a second position. A seat attachment is rotatably connected to the incline member. The seat attachment is rotatable relative to the incline member between a first rotational configuration and a second rotational configuration. The seat attachment is configured to detachably connect to the child seat. The incline member can move between the first position and the second position when the seat attachment is in the first rotational configuration and the second rotational configuration.

In addition to one or more of the features described above, or as an alternative, in further embodiments the seat attachment is rotatable relative to the incline member at any position of the incline member relative to the incline path.

In addition to one or more of the features described above, or as an alternative, in further embodiments the incline member is movable along the incline path regardless at any rotational configuration of the seat attachment.

In addition to one or more of the features described above, or as an alternative, in further embodiments the support base further includes a belt receiving path for a vehicle belt associated with the vehicle seat and an exterior surface of the base body.

In addition to one or more of the features described above, or as an alternative, in further embodiments the support base further includes a belt tensioner mounted to the base body. The belt tensioner is movable to apply a tension to the vehicle belt.

In addition to one or more of the features described above, or as an alternative, in further embodiments the incline member is located remotely from the belt receiving path such that the tension applied to the vehicle belt by the belt tensioner is unaffected by movement of the incline member between the first position and the second position.

In addition to one or more of the features described above, or as an alternative, in further embodiments the base body further includes at least one elongated slot and the incline member is coupled to the at least one elongated slot. The at least one elongated slot defines the incline path of the incline member between the first position and the second position.

In addition to one or more of the features described above, or as an alternative, in further embodiments the base body further includes a seat portion and a back portion. The back portion is arranged at an angle relative to the seat portion.

In addition to one or more of the features described above, or as an alternative, in further embodiments the incline member further comprises a first leg and a second leg. Each of the first and second leg has an upper portion and a lower portion and the upper portions of the first and second legs are connected by a connecting member.

In addition to one or more of the features described above, or as an alternative, in further embodiments the upper portions are arranged within the back portion and the lower portion is arranged within the seat portion.

In addition to one or more of the features described above, or as an alternative, in further embodiments an angle formed between the upper portion and the lower portion of the first leg and the second leg is equal to the angle formed between the seat portion and the back portion of the base body.

In addition to one or more of the features described above, or as an alternative, in further embodiments the incline member further comprises a base anchor member connectable to a seat anchor member of the child seat.

In addition to one or more of the features described above, or as an alternative, in further embodiments the first rotational configuration is a forward-facing position and the second rotational configuration is a rearward facing position.

In addition to one or more of the features described above, or as an alternative, in further embodiments the seat attachment further comprises a support platform connectable to the child seat and an attachment member coupled to the support platform. The support platform being in axial overlapping arrangement with the attachment member.

In addition to one or more of the features described above, or as an alternative, in further embodiments the attachment member further includes an opening and the incline member further includes a mounting post. The mounting post being receivable within the opening to define an axis of rotation of the seat attachment.

In addition to one or more of the features described above, or as an alternative, in further embodiments the incline member is movable relative to the base body along the incline path.

According to an embodiment, a support base for a child restraint system is attachable to a vehicle seat by a vehicle belt. The support base includes a base body having a top surface and a bottom surface. The bottom surface is positionable on the vehicle seat. An incline member is movably mounted to the base body. The incline member is movable along an incline path between a first position and a second position. A belt receiving path for receiving the vehicle belt to secure support base to the vehicle seat is at least partially defined by the top surface. The incline member is movable between the first position and the second position without impacting a position of the vehicle belt on the belt receiving path.

In addition to one or more of the features described above, or as an alternative, in further embodiment the support base further includes a belt tensioner. The belt receiving path extends between the belt tensioner and the top surface of the base body. The belt tensioner is movable to apply a tension to the vehicle belt.

In addition to one or more of the features described above, or as an alternative, in further embodiments the base body further includes at least one elongated slot and the incline member is coupled to the at least one elongated slot. The at least one elongated slot defines the incline path of the incline member between the first position and the second position.

In addition to one or more of the features described above, or as an alternative, in further embodiments the base body further includes a seat portion and a back portion. The back portion being arranged at an angle relative to the seat portion.

In addition to one or more of the features described above, or as an alternative, in further embodiments the incline member further includes a first leg and a second leg. Each of the first and second legs has an upper portion and a lower portion and the upper portions of the first and second legs are connected by a connecting member.

In addition to one or more of the features described above, or as an alternative, in further embodiments the upper portion is arranged within the back portion and the lower portion is arranged within the seat portion.

In addition to one or more of the features described above, or as an alternative, in further embodiments an angle formed between the upper portion and the lower portion of the first leg and the second leg is equal to the angle formed between the seat portion and the back portion of the base body.

In addition to one or more of the features described above, or as an alternative, in further embodiments the incline member is movable relative to the base body along the incline path.

In addition to one or more of the features described above, or as an alternative, in further embodiments the incline member is movable between the first position and the second position without impacting a tension in the vehicle belt on the belt receiving path.

According to an embodiment, a support base for a child restraint system including a child seat having a seat portion and a back portion extending therefrom is provided. The support base includes a base body and an incline member movably connected to the base body. The incline member is movable along an incline path between a first position and a second position. A seat attachment is connected to the incline member. The seat attachment is detachably connectable to the seat portion of the child seat. A base anchor member is fixedly connected to the incline member and is connectable with a seat anchor member of the child seat.

In addition to one or more of the features described above, or as an alternative, in further embodiments the seat anchor member is arranged at the back portion of the child seat.

In addition to one or more of the features described above, or as an alternative, in further embodiments the seat attachment is rotatably connected to the incline member. The seat attachment is rotatable between a first rotational configuration and a second rotational configuration.

In addition to one or more of the features described above, or as an alternative, in further embodiments the base anchor member is connectable to the seat anchor member when the seat attachment is in the first rotational configuration.

In addition to one or more of the features described above, or as an alternative, in further embodiments the base anchor member is not connectable to the seat anchor member when the seat attachment is in the second rotational configuration.

In addition to one or more of the features described above, or as an alternative, in further embodiments the base anchor member is connectable to the seat anchor member when the child seat is in a forward-facing configuration.

In addition to one or more of the features described above, or as an alternative, in further embodiments the incline member is movable relative to the base body along the incline path.

In addition to one or more of the features described above, or as an alternative, in further embodiments a tether assembly includes a tether support arranged within an interior of the base body and a tether strap extendable through an opening formed in the base body. The tether strap is positionable in contact with the tether support when extended through the opening.

In addition to one or more of the features described above, or as an alternative, in further embodiments the opening is arranged adjacent to the base anchor member.

According to an embodiment, a support base for a child restraint system suitable for placement on a vehicle seat is provided. The child restraint system includes an infant child seat and a convertible child seat. The support base includes a base body and a seat attachment connected to the base body. The seat attachment is rotatable about an axis relative to the base body between a first rotational configuration and a second rotational configuration. The biasing mechanism allowable rotation between the first rotational configuration and the second rotational configuration varies based on which of the first child seat and the second child seat is connected to the seat attachment.

In addition to one or more of the features described above, or as an alternative, in further embodiments the seat attachment is rotatable 180 degrees between the first rotational configuration and the second rotational configuration when the first child seat is connected to the seat attachment.

In addition to one or more of the features described above, or as an alternative, in further embodiments the first child seat is a convertible child seat.

In addition to one or more of the features described above, or as an alternative, in further embodiments the seat attachment is rotatable less than 180 degrees between the first rotational configuration and the second rotational configuration when the second child seat is connected to the seat attachment.

In addition to one or more of the features described above, or as an alternative, in further embodiments the seat attachment is rotatable 90 degrees between the first rotational configuration and the second rotational configuration when the second child seat is connected to the seat attachment.

In addition to one or more of the features described above, or as an alternative, in further embodiments the second child seat is an infant child seat.

According to an embodiment, a support base for a child restraint system suitable for placement on a vehicle seat, is provided. The support base includes a base body and an incline member movably mounted to the base body. A seat attachment is coupled to the incline member. The incline member and the seat attachment are movable along a path of movement relative to the base body between a first position and a second position.

In addition to one or more of the features described above, or as an alternative, in further embodiments the seat attachment is rotatably connected to the incline member. The seat attachment is rotatable relative to the incline member between a first rotational configuration and a second rotational configuration.

In addition to one or more of the features described above, or as an alternative, in further embodiments the first rotational configuration is a forward-facing position and the second rotational configuration is a rearward facing position.

In addition to one or more of the features described above, or as an alternative, in further embodiments the seat attachment is rotatable relative to the incline member at any position of the incline member relative to the path of movement.

In addition to one or more of the features described above, or as an alternative, in further embodiments the support base further includes a belt receiving path for a vehicle belt associated with the vehicle seat and an exterior surface of the base body.

In addition to one or more of the features described above, or as an alternative, in further embodiments the support base further includes a belt tensioner mounted to the base body. The belt tensioner being movable to apply a tension to the vehicle belt.

In addition to one or more of the features described above, or as an alternative, in further embodiments the incline member is located remotely from the belt receiving path such that the tension applied to the vehicle belt by the belt tensioner is unaffected by movement of the incline member over the path of movement.

In addition to one or more of the features described above, or as an alternative, in further embodiments the base body further includes at least one elongated slot and the incline member is coupled to the at least one elongated slot. The at least one elongated slot defines the path of movement of the incline member between the first position and the second position.

In addition to one or more of the features described above, or as an alternative, in further embodiments the base body further includes a seat portion and a back portion. The back portion being arranged at an angle relative to the seat portion.

In addition to one or more of the features described above, or as an alternative, in further embodiments the incline member further includes a first leg and a second leg. Each of the first and second legs has an upper portion and a lower portion. The upper portions of the first and second legs are connected by a connecting member.

In addition to one or more of the features described above, or as an alternative, in further embodiments the upper portion is arranged within the back portion and the lower portion is arranged within the seat portion.

In addition to one or more of the features described above, or as an alternative, in further embodiments an angle formed between the upper portion and the lower portion of the first leg and the second leg is equal to the angle formed between the seat portion and the back portion of the base body.

In addition to one or more of the features described above, or as an alternative, in further embodiments the incline member further includes a base anchor member connectable to a seat anchor member of a child seat of the child restraint system.

According to an embodiment, a child seat for a child seat system including a seat base for placement on a vehicle seat. The child seat including a seat portion connectable to the seat base and a back portion extending from the seat portion. A seat anchor member is attached to the back portion. The seat anchor member is connectable to a base anchor member of the seat base. The child seat is rotatable relative to the seat base between a first rotational configuration and a second rotational configuration. In the first rotational configuration, the seat anchor member is connected to the base anchor member, and in the second rotational configuration, the seat anchor member is spaced from the base anchor member. The seat anchor member is configured to self-align with the base anchor member such that as the child seat rotates from the second rotational configuration to the first rotational configuration, the seat anchor member aligns with the base anchor member.

In addition to one or more of the features described above, or as an alternative, in further embodiments the child seat is movable relative to the seat base between a first inclination position and a second inclination position. As the child seat transitions between the first inclination position and the second inclination position, a connection between the seat anchor member and the base anchor member moves relative to either one of the child seat and the seat base.

In addition to one or more of the features described above, or as an alternative, in further embodiments a headrest is arranged at the back portion. The headrest includes a main body and a side impact portion removably coupled to the main body.

In addition to one or more of the features described above, or as an alternative, in further embodiments including a seat frame disposed within the seat portion and a harness assembly including a crotch strap. The crotch strap is coupled to the seat frame via an anchor pin

In addition to one or more of the features described above, or as an alternative, in further embodiments including a harness assembly having a crotch strap. A slider is movably mounted within the seat portion. The crotch strap is coupled to the slider. Movement of the slider relative to the seat portion tightens the crotch strap.

According to an embodiment, a support base for a child restraint system including a child seat includes a base body, a seat attachment rotatably coupled to the base body, and a lock mechanism. The seat attachment is connectable to the child seat. The lock mechanism includes a lock member transitionable between a locked position, in which the lock member engages the seat attachment to prevent rotation of the seat attachment relative to the base body, and an unlocked position, in which the lock member is disengaged from the seat attachment. A first actuator is operably coupled to the lock member to selectively transition the lock member between the locked position and the unlocked position and a second actuator is operably coupled to the lock member to selectively transition the lock member between the locked position to the unlocked position.

In addition to one or more of the features described above, or as an alternative, in further embodiments the first actuator and the second actuator are independently operable to transition the lock member between the locked position and the unlocked position.

In addition to one or more of the features described above, or as an alternative, in further embodiments the first actuator is arranged at the base body and the second actuator is located about the child seat.

In addition to one or more of the features described above, or as an alternative, in further embodiments the first actuator is operable to pull the lock member to transition the lock member between the locked position and the unlocked position and the second actuator is operable to push the lock member to transition the lock member between the locked position and the unlocked position.

In addition to one or more of the features described above, or as an alternative, in further embodiments including a biasing mechanism operably coupled to the lock member. A biasing force of the biasing mechanism biases the lock member to the locked position.

In addition to one or more of the features described above, or as an alternative, in further embodiments the seat attachment includes a support platform having an annular collar. The lock member engages a portion of the annular collar to prevent rotation of the seat attachment relative to the base body.

In addition to one or more of the features described above, or as an alternative, in further embodiments the annular collar further includes at least one opening formed therein. The lock member is receivable within the at least one opening in the locked position.

In addition to one or more of the features described above, or as an alternative, in further embodiments the at least one opening further includes a first opening arranged at a position about the annular collar associated with the child seat in a forward-facing configuration and a second opening arranged at another position about the annular collar associated with the child seat in a rearward-facing configuration.

According to an embodiment, a support base for a child restraint system suitable for placement on a vehicle seat, the child restraint system including a first child seat and a second child seat. The support base includes a base body and a seat attachment connectable to the first child seat and to the second child seat. The seat attachment is rotatable relative to the base body between a first rotational configuration and a second rotational configuration. A spin lock-out mechanism is operably connected between the base body and the seat attachment. The spin lock-out mechanism includes a first spin lock member fixedly connected to the base body and a second spin lock member connected to the seat attachment. The second spin lock member is rotatable relative to the first spin lock member. The second spin lock member is transformable between a lockable configuration and a free configuration. The second spin lock member is in said free configuration when the first child seat is connected to the seat attachment and the second spin lock member is in the lockable configuration when the second child seat is connected to the seat attachment.

In addition to one or more of the features described above, or as an alternative, in further embodiments the first child seat is a convertible child seat and the second child seat is an infant child seat.

In addition to one or more of the features described above, or as an alternative, in further embodiments the convertible child seat is a toddler seat.

In addition to one or more of the features described above, or as an alternative, in further embodiments in the free configuration, the second spin lock member is rotatable 360 degrees.

In addition to one or more of the features described above, or as an alternative, in further embodiments in said lockable configuration, the second spin lock member is rotatable about an axis less than 360 degrees.

In addition to one or more of the features described above, or as an alternative, in further embodiments in the free configuration, the second spin lock member is rotatable relative to the first spin lock member between the first rotational configuration and the second rotational configuration. In the lockable configuration, the second spin lock member is restricted from rotating to the first rotational configuration.

In addition to one or more of the features described above, or as an alternative, in further embodiments the first rotational configuration is a forward-facing position and the second rotational configuration is a rearward-facing position.

In addition to one or more of the features described above, or as an alternative, in further embodiments in the lockable configuration, a portion of the first spin lock member is arranged within a path of rotation of the second spin lock member.

In addition to one or more of the features described above, or as an alternative, in further embodiments the first spin lock member includes a protrusion and during rotation of the second spin lock member in the lockable configuration, the second spin lock member engages the protrusion.

In addition to one or more of the features described above, or as an alternative, in further embodiments in the free configuration, the path of rotation of the second spin lock member is arranged radially outward of the protrusion.

In addition to one or more of the features described above, or as an alternative, in further embodiments the second spin lock member is rotatable about an axis between the free configuration and the lockable configuration.

In addition to one or more of the features described above, or as an alternative, in further embodiments the second spin lock member further includes a shaft mounted to the seat attachment, an engagement member affixed to the shaft, and a biasing mechanism operably coupled to the engagement member. A biasing force of the biasing mechanism biases the second spin lock member to the lockable configuration.

In addition to one or more of the features described above, or as an alternative, in further embodiments the shaft is rotatable about a shaft axis relative to the seat attachment between the free configuration and the lockable configuration.

In addition to one or more of the features described above, or as an alternative, in further embodiments an intermediate shaft of the second child seat connectable to the seat attachment is operable to oppose the biasing force of said biasing mechanism.

In addition to one or more of the features described above, or as an alternative, in further embodiments including a lock member transitionable between a locked position and an unlocked position. The seat attachment is restricted from rotating relative to the base body when the lock member is in the locked position.

In addition to one or more of the features described above, or as an alternative, in further embodiments the first spin lock member includes at least one locking feature. The lock member is engaged with the at least one locking feature in the locked position and the lock member is disengaged from the at least one locking feature in the unlocked position.

In addition to one or more of the features described above, or as an alternative, in further embodiments an actuator is operably coupled to the lock member to transform the locked member from the locked position to the unlocked position. The actuator is mounted to the seat attachment and is rotatable with the seat attachment relative to the base body.

According to an embodiment, a support base for a child restraint system installable on a vehicle seat, the child restraint system including a child seat, the support base includes a base body, and a seat attachment connectable to the child seat. The seat attachment is rotatable relative to the base body between a first rotational configuration and a second rotational configuration. A removal lock member is connected to the seat attachment. The removal lock member is movable between a locked position and an unlocked position. The removal lock member is arrangeable in the locked position when the seat attachment having the child seat connected thereto is in the first rotational configuration relative to the base body and the removal lock member is arrangeable in the unlocked position when the seat attachment having the child seat connected thereto is in said second rotational configuration relative to the base body.

In addition to one or more of the features described above, or as an alternative, in further embodiments the child seat is separable from the seat attachment when the removal lock member is in the unlocked position and the child seat is inseparable from the seat attachment when the removal lock member is in the locked position.

In addition to one or more of the features described above, or as an alternative, in further embodiments the first rotational configuration is a forward-facing configuration.

In addition to one or more of the features described above, or as an alternative, in further embodiments the removal lock member is rotatable between said unlocked position and said locked position.

In addition to one or more of the features described above, or as an alternative, in further embodiments the removal lock member is fixedly mounted to a shaft and the shaft is rotatable about a shaft axis.

In addition to one or more of the features described above, or as an alternative, in further embodiments the removal lock member further includes an engagement feature. The engagement feature is engaged with the child seat when the removal lock member is in the locked position.

In addition to one or more of the features described above, or as an alternative, in further embodiments the child seat reaches the second rotational configuration when the child seat has rotated a distance from the first rotational configuration such that the engagement feature is disengaged with the child seat.

In addition to one or more of the features described above, or as an alternative, in further embodiments the engagement feature is a hook.

In addition to one or more of the features described above, or as an alternative, in further embodiments the child seat is a toddler seat.

In addition to one or more of the features described above, or as an alternative, in further embodiments the child seat further includes an intermediate shaft engageable by the engagement feature when the removal lock member is in the locked position.

According to an embodiment, a support base for a child restraint system including a child seat includes a base body, a seat attachment rotatably coupled to the base body and connectable to the child seat. A spin lock-out mechanism affixed to base body includes at least one locking feature. A lock mechanism includes a lock member transitionable between a locked position in which the seat attachment is restricted from rotating relative to the base body and an unlocked position in which the seat attachment is rotatable relative to said base body. The lock member is engaged with the at least one locking feature in the locked position and the lock member is disengaged from the at least one locking feature in the unlocked position.

In addition to one or more of the features described above, or as an alternative, in further embodiments the lock member is mounted to the seat attachment.

In addition to one or more of the features described above, or as an alternative, in further embodiments including an actuator operably coupled to the lock member to transform the locked member from the locked position to the unlocked position. The actuator is mounted to the seat attachment and is rotatable with the seat attachment relative to the base body.

### BRIEF DESCRIPTION OF THE DRAWINGS

The following descriptions should not be considered limiting in any way. With reference to the accompanying drawings, like elements are numbered alike:

FIG. 1A is a perspective view of a support base of a child safety system according to an embodiment;

FIG. 1B is a side view of a support base of a child safety system according to an embodiment;

FIG. 2 is a perspective view of a seat receiving assembly of the support base of FIG. 1 according to an embodiment;

FIG. 3 is an exploded perspective view of the seat receiving assembly of FIG. 2 according to an embodiment;

FIG. 4 is a perspective view of the base member and a portion of the seat receiving assembly according to an embodiment;

FIG. 5 is a top view of the incline member according to an embodiment;

FIG. 6 is a perspective view of a seat attachment of the seat receiving assembly according to an embodiment;

FIG. 7 is a perspective view of a portion of the seat receiving assembly according to an embodiment;

FIG. 8 is a cross-sectional view of the support base including a portion of the seat receiving assembly according to an embodiment;

FIG. 9 is a top view of the incline member and a portion of the base member according to an embodiment;

FIG. 10 is a side view of the incline member and a corresponding portion of the base member according to an embodiment;

FIG. 11A is a perspective view of a portion of the support plate of the seat receiving assembly according to an embodiment;

FIG. 11B is a perspective view of an interior portion of the base body according to an embodiment;

FIG. 12A is a perspective view of the support plate mounted within the base body when the incline member is at a first inclined position according to an embodiment;

FIG. 12B is a perspective view of the support plate mounted within the base body when the incline member is at a second inclined position according to an embodiment;

FIG. 13A is a perspective view of a first child seat mounted to the support base in a first inclined position and a first rotational configuration according to an embodiment;

FIG. 13B is a perspective view of a first child seat mounted to the support base in a first inclined position and a second rotational configuration according to an embodiment;

FIG. 14A is a perspective view of a second child seat mounted to the support base in a first inclined position and a first rotational configuration according to an embodiment;

FIG. 14B is a perspective view of a second child seat mounted to the support base in a first inclined position and a second rotational configuration according to an embodiment;

FIG. 15A is a perspective view of a first child seat mounted to the support base in a second inclined position and a first rotational configuration according to an embodiment;

FIG. 15B is a perspective view of a first child seat mounted to the support base in a second inclined position and a second rotational configuration according to an embodiment;

FIG. 16A is a perspective view of a second child seat mounted to the support base in a second inclined position and a first rotational configuration according to an embodiment;

FIG. 16B is a perspective view of a second child seat mounted to the support base in a second inclined position and a second rotational configuration according to an embodiment;

FIG. 17 is a side view of a support base installed on a vehicle seat according to an embodiment;

FIG. 18 is a front view of a support base having a vehicle belt extending through a belt receiving path of the support base according to an embodiment;

FIG. 19 is a perspective view of a convertible child seat configured to mount to a support body according to an embodiment;

FIG. 20A is a perspective view of a support base having a belt tensioner in a locked position according to an embodiment;

FIG. 20B is a perspective view of the belt tensioner of FIG. 20A in an unlocked position according to an embodiment;

FIG. 21A is a front perspective view of a support base having at least one belt guide according to an embodiment;

FIG. 21B is a rear perspective view of the support base of FIG. 21A according to an embodiment;

FIG. 21C is a front perspective view of the support base of FIG. 21A with a vehicle belt connected thereto according to an embodiment;

FIG. 22 is a side view of a first child seat connected to the support base in a forward-facing configuration according to an embodiment;

FIG. 23 is a perspective view of a support base of a child safety system according to another embodiment;

FIG. 24A is a perspective view of a support base of a child safety system having an extended stability leg according to another embodiment;

FIG. 24B is a front view of the support base of FIG. 24A according to an embodiment;

FIG. 25A is a perspective view of a seat assembly 40 of a support base of a child safety system according to another embodiment;

FIG. 25B is an exploded perspective view of the seat assembly of FIG. 25A according to an embodiment;

FIG. 26 is a side view of a portion of the seat attachment FIG. 23 mounted to a support plate according to an embodiment;

FIG. 27 is a perspective view of a seat attachment of FIG. 23 according to an embodiment;

FIG. 28 is a bottom perspective view of the seat of FIG. 23 and a corresponding lock mechanism in an engaged position according to an embodiment;

FIG. 29A is a bottom perspective view of the seat of FIG. 23 and a corresponding spin lock-out mechanism according to an embodiment;

FIG. 29B is a bottom perspective view of the seat and the spin lock-out mechanism of FIG. 29A with a first spin lock member of the spin lock-out mechanism removed according to an embodiment;

FIG. 30A is a cross-sectional view of a locking mechanism of the support base of FIG. 24B taken along line 30-30 in a locked position according to an embodiment;

FIG. 30B is a cross-sectional view of a locking mechanism of the support base of FIG. 24B taken along line 30-30 in an unlocked position according to an embodiment;

FIG. 31 is a plan view of the seat assembly of the support base without the seat attachment according to an embodiment;

FIG. 32A is a perspective view of a toddler seat connectable to the seat attachment according to an embodiment;

FIG. 32B is a perspective view of an infant child seat connectable to the seat attachment according to an embodiment;

FIG. 33A is a bottom perspective view of a spin lock-out mechanism when the seat attachment is arranged between a forward-facing configuration and a rearward-facing configuration according to an embodiment;

FIG. 33B is a bottom perspective view of a spin lock-out mechanism when a first child seat is connected to the seat attachment and is arranged at a forward-facing configuration according to an embodiment;

FIG. 33C is a bottom perspective view of a spin lock-out mechanism when a second child seat is connected to the seat attachment and is arranged at a forward-facing configuration according to an embodiment;

FIG. 34A is a side perspective view of a spin lock-out mechanism when a first child seat is connected to the seat attachment and is not arranged at a forward-facing configuration according to an embodiment;

FIG. 34B is a side perspective view of a spin lock-out mechanism when a first child seat is connected to the seat attachment and is arranged at a forward-facing configuration according to an embodiment;

FIG. 35 is a bottom perspective view of an incline locking mechanism associated with the incline member according to an embodiment;

FIG. 36 is another bottom perspective view of an incline locking mechanism associated with the incline member according to an embodiment;

FIG. 37 is a detailed perspective view of the incline locking mechanism of FIG. 36 and a release actuator according to an embodiment;

FIG. 38 is a cross-sectional view of a locking mechanism of the support base of FIG. 24B taken along line 38-38 according to an embodiment;

FIG. 39A is a perspective view of a first child seat mounted to the support base according to an embodiment;

FIG. 39B is side view of the first child seat mounted to the support base of FIG. 38A according to an embodiment;

FIG. 39C is a front view of a first child seat mounted to the support base of FIG. 38A according to an embodiment;

FIG. 40 is side view of the first child seat having a side impart portion separated from the headrest according to an embodiment;

FIG. 41A is a perspective view of a first child seat mounted directly to a vehicle seat according to an embodiment;

FIG. 41B is another perspective view of a first child seat mounted directly to a vehicle seat according to an embodiment;

FIG. 42A is a front perspective view of vehicle belt path associate for use when the first child seat mounted directly to a vehicle seat according to an embodiment;

FIG. 42B is a side perspective view of vehicle belt path associate for use when the first child seat mounted directly to a vehicle seat according to an embodiment;

FIG. 43A is a rear perspective view of a first child seat according to an embodiment;

FIG. 43B is a rear perspective view of the first child seat of FIG. 43A having a transparent exterior surface and a corresponding anchor strap storage location according to an embodiment;

FIG. 43C is a rear perspective view of the first child seat of FIG. 43A having a transparent exterior surface and another corresponding anchor strap storage location according to an embodiment;

FIG. 44 is a bottom perspective view of portion of the first child seat according to an embodiment

FIG. 45 is a cross-sectional view of a seat portion of a first child seat including a harness assembly according to an embodiment;

FIG. 46 is a side view of a frame of the seat portion of a first child seat when the first child seat is mounted to the seat attachment according to an embodiment;

FIG. 47A is a perspective view of a support base having an extended stability leg according to an embodiment;

FIG. 47B is a perspective view of a support base having an extended stability leg according to another embodiment;

FIG. 48A is a rear perspective view of a portion of a support base according to an embodiment;

FIG. 48B is a partially transparent rear perspective view of the portion of the support base of FIG. 48A according to an embodiment;

FIG. 49A is a perspective view of a portion of the support base of FIG. 48A with the housing removed according to an embodiment;

FIG. 49B is another perspective view of the portion of the support base of FIG. 49A according to an embodiment;

FIG. 50A is a perspective view of a seat back of a first child seat including a seat anchor member according to an embodiment;

FIG. 50B is another perspective view of the seat back of FIG. 50A with a portion of the housing removed according to an embodiment;

FIG. 51 is a perspective view of an interface of a base anchor member and a seat anchor member according to an embodiment; and

FIG. 52 is a perspective view of an interface of a base anchor member and a seat anchor member according to another embodiment.

### DETAILED DESCRIPTION

A detailed description of one or more embodiments of the disclosed apparatus and method are presented herein by way of exemplification and not limitation with reference to the Figures.

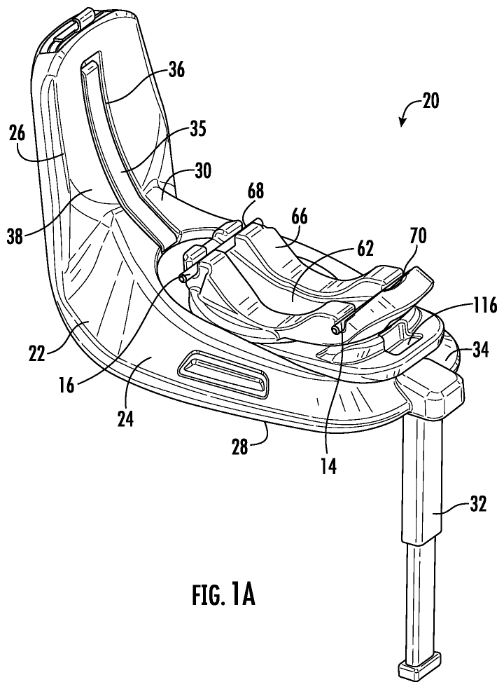

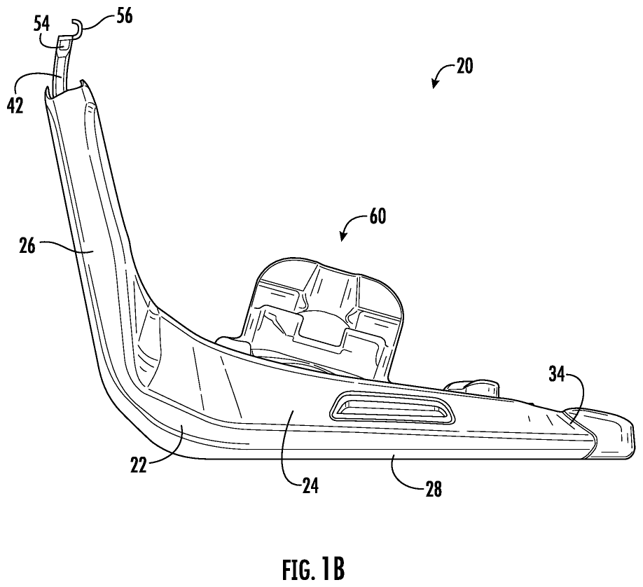

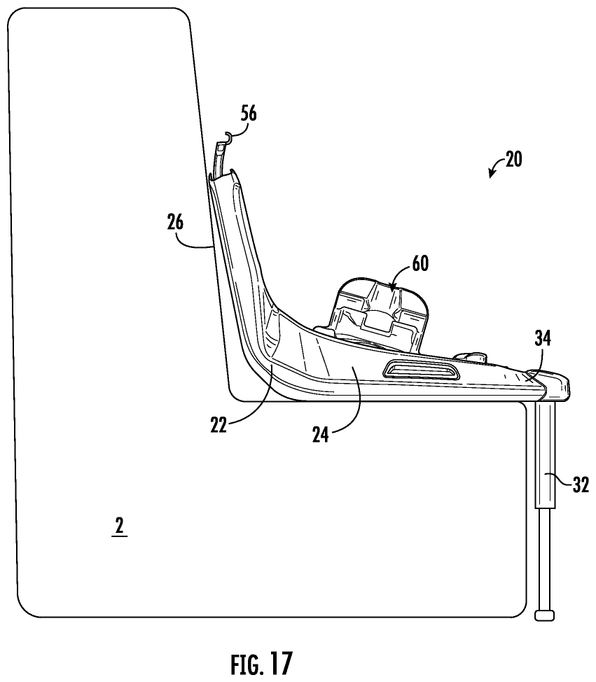

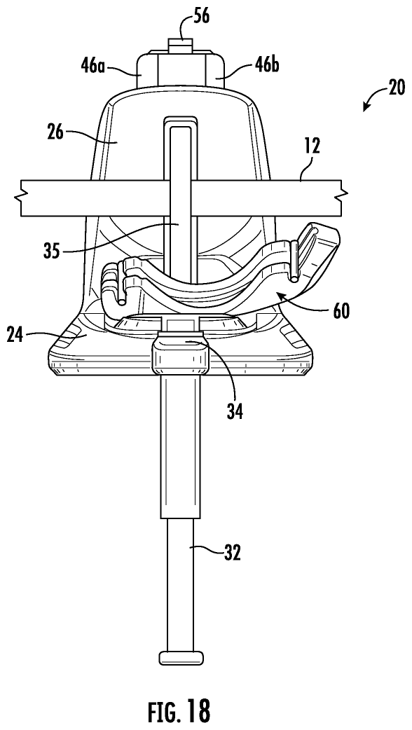

With reference now to the FIG. 1, an example of a support base 20 for use in a child restraint system and that is configured to receive a child safety seat is illustrated according to an embodiment. The support base 20 can be detachably fixed to a vehicle seat 2 (FIG. 17), such as via a latch or anchor mechanism, not shown in the FIGS. This latch or anchor system often used is sometimes referred to as a “lower anchor and tether for children” e.g., LATCH system. Alternatively, or in addition, as will be described in more detail below, the support base 20 may be detachably fixed to a vehicle seat 2 via a vehicle belt 12 (see FIG. 18) associated with the vehicle seat 2.

As shown, the support base 20 includes a base body 22 having a seat portion 24 and a back portion 26. Suitable materials for making the base body 22 include but are not limited to rigid plastic or composite materials for example. Although the seat portion 24 and the back portion 26 are illustrated as being integrally formed as a unitary body, embodiments where the seat portion 24 and the back portion 26 are separate components removably or permanently connected together are also within the scope of the disclosure. The seat portion 24 has a bottom surface 28 suitable for placement on a support surface, such as a vehicle seat (see FIG. 17). The back portion 26 may be arranged at a first end 30 of the seat portion 24 and extends at an angle relative thereto. In the illustrated, non-limiting embodiment, the back portion 26 is oriented at an angle between about 75 degrees and about 120 degrees relative to the bottom surface 28 of the seat portion 24. However, it should be understood that embodiments where the angle formed between the back portion 26 and the bottom surface of the seat portion 24 is less than 75 degrees or is greater than 120 degrees are also contemplated herein.

In the illustrated, non-limiting embodiment, a stability leg 32 having a fixed or adjustable length is connected to a portion of the base body 22, such as the second, opposite end 34 of the seat portion 24 for example. The stability leg 32 can be rotatable or foldable relative to the seat portion 24 between an extended configuration (FIG. 1A), in which the stability leg 32 abuts against a vehicle floor, and a retracted configuration (FIG. 1B), in which the stability leg 32 is stowed underneath or within the seat portion 24 of the support base 20. When in the retracted configuration, the stability leg may protrude slightly from the bottom surface 28 of the seat portion 24 such as to encourage the use of the stability leg 32 during installation of the support base 20 about a vehicle seat 2.

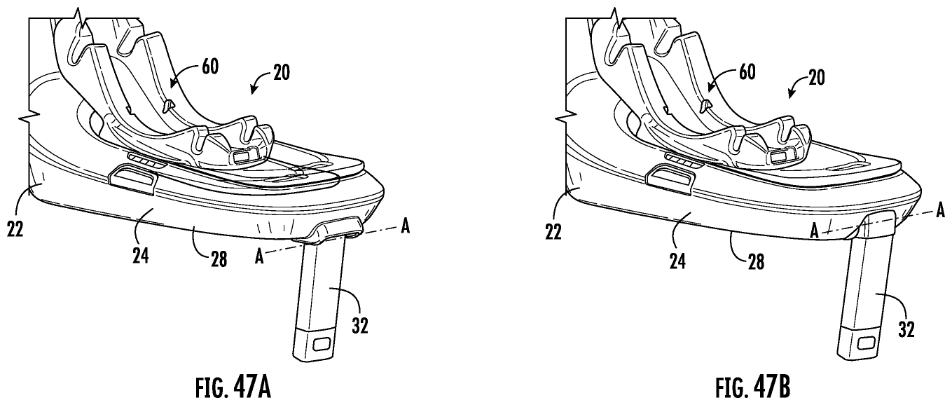

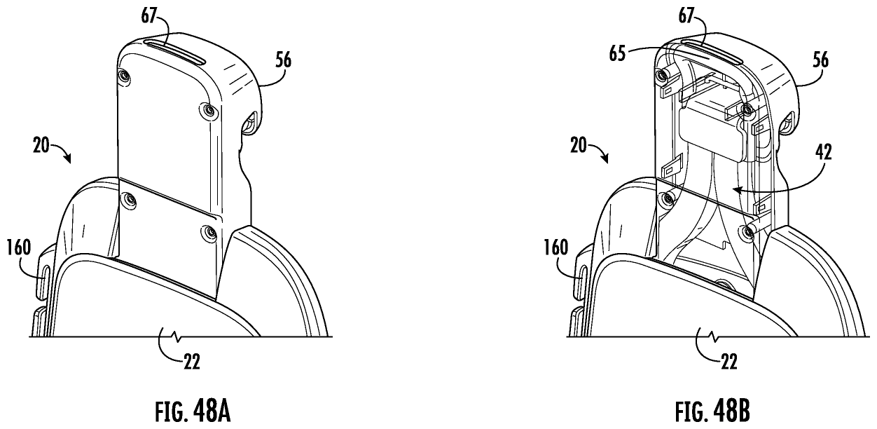

With reference to FIG. 47A, in an embodiment, the axis of rotation A of the stability leg 32 may be located within the plane defined by the bottom surface 28 of the seat portion 24. In other embodiments, the axis of rotation A of the stability leg 32 may be vertically offset from the bottom surface of the seat portion 24. For example, as shown in FIG. 47B, the axis of rotation may be arranged generally centrally between an upper surface and the bottom surface 28 of the seat portion 24. However, it should be appreciated that a stability leg having an axis of rotation location at any position between the upper and bottom surfaces 28 of the seat portion, and even vertically beneath the bottom surface 28 of the seat portion 24 are within the scope of the disclosure.

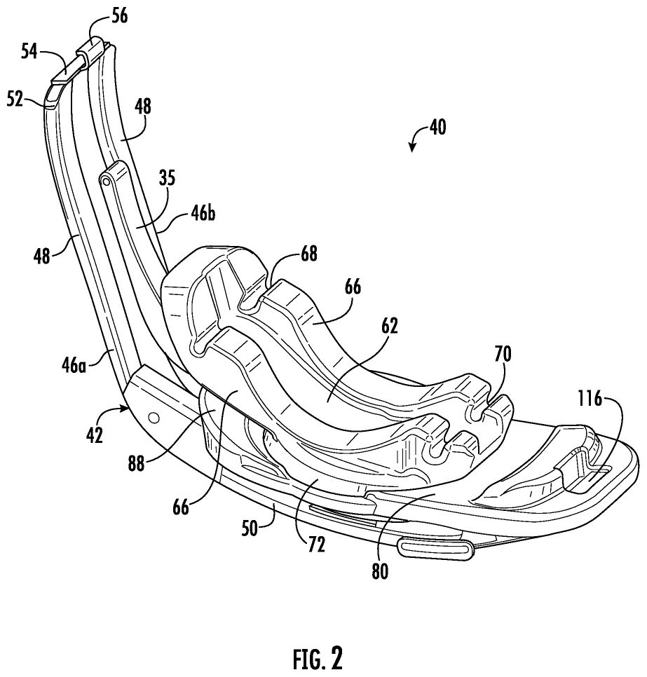

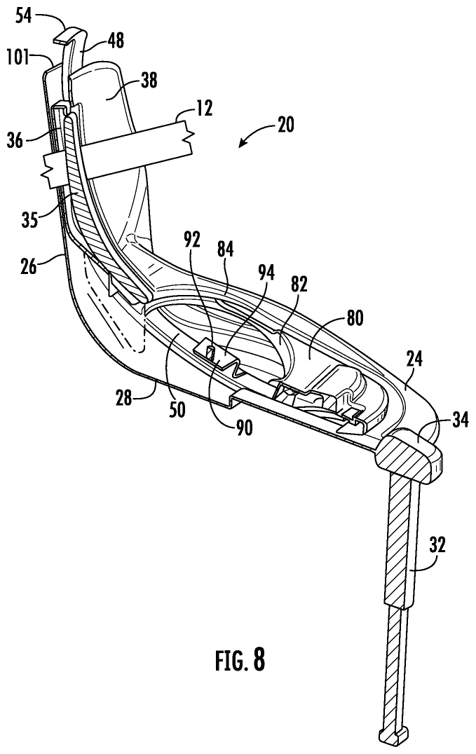

With continued reference to FIG. 1A, and further reference to FIGS. 2-4, 8 and 16, the support base 20 may include a belt tensioner 35 coupled to the base body 22. In the illustrated, non-limiting embodiment, a groove 36 formed in the base body 22 extends from the seat portion 24 into the back portion 26 and the belt tensioner 35 is receivable within the groove 36. However, it should be appreciated that embodiments where the groove 36 is only formed in the back portion 26 of the base body 22 are also contemplated herein. A contour of the belt tensioner 35 may be complementary to that of the groove 36 such that the substantial entirety of the belt tensioner 35 is receivable within the groove 36. A vehicle belt 12 associated with the vehicle seat on which the support base 20 is positionable may be arranged along a belt receiving path defined between an exterior or top surface 38 of the base body 22, such as of the back portion 26 of the base body 22 for example, and the belt tensioner 35. In an embodiment, the belt tensioner 35 is selectively movable relative to the base body 22 to adjust the tension applied to the vehicle belt 12 along the vehicle belt receiving path. For example, the belt tensioner 35 may be configured to pivot about at least one axis to selectively pinch the portion of the vehicle belt 12 sandwiched between the belt tensioner 35 and the groove 36 to couple the support base 20 to the vehicle belt 12, thereby restricting movement of the support base 20 relative to the vehicle seat.

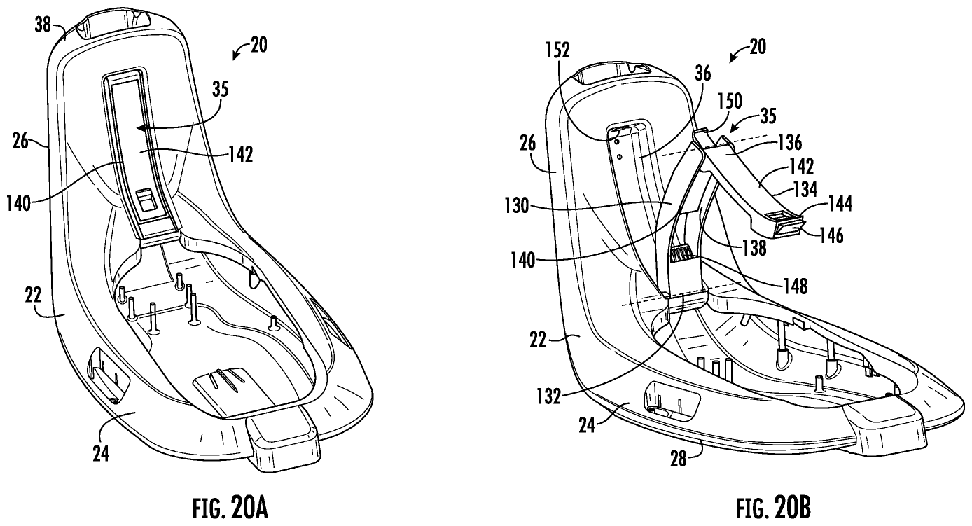

In the non-limiting embodiment of FIGS. 2-4, 8 and 16, the belt tensioner 35 is formed from a single member that is pivotably connected to the support base 20 at a first end thereof. However, in other embodiments, such as shown in FIGS. 20A and 20B, the belt tensioner 35 may be an assembly including a plurality of tensioning members operably coupled together. In the illustrated non-limiting embodiment, the belt tensioner 35 includes a first tensioning member 130 movably coupled to the support base 20 at a first end 132 thereof and a second tensioning member 134 movably coupled to the first tensioning member 130, such as at a second, opposite end 136 thereof. Although the first tensioning member 130 is illustrated as being rotatably coupled to the support base 20 and the second tensioning member 134 is illustrated as being rotatably coupled to the first tensioning member 130, embodiments where one or both of the first and second tensioning members 130, 134 is movable in another manner are also contemplated herein. Furthermore, embodiments where the second tensioning member 134 is movably coupled directly to the support base 20 rather than to the first tensioning member 130 are also within the scope of the disclosure

In an unlocked position, as shown in FIG. 20B, the first tensioning member 130 of the belt tensioner 35 is rotated away from the groove 36 and the second tensioning member 134 is arranged at a non-parallel angle to the first tensioning member 130. In such embodiments, a respective biasing mechanism (not shown) may be associated with each of the respective axes of rotation of the first and second tensioning members 130, 134. In the locked position, the first and second tensioning members 130, 134 are arranged generally parallel to one another. In the illustrated, non-limiting embodiment, the first tensioning member 130 has a recess 138 formed at a first surface 140 thereof, such as the surface configured to face towards a seat receivable on the support base 20. The size of the recess 138 may be complementary to the second tensioning member 134 such that the second tensioning member 134 is nestable within the recess 138 of the first tensioning member 130. In such embodiments, a surface 142 of the second tensioning member 134 facing towards a seat receivable on the support base may be generally flush with the first surface 140 of the first tensioning member 130. In other embodiments, the recess may be formed in a back surface of the second tensioning member 134 such that the first tensioning member 130 is nestable within the second tensioning member 134.

When in a locked position, as shown in FIG. 20A, the second tensioning member 134 is arranged parallel to the first tensioning member 130. A distal end 144 of the second tensioning member 134 may be selectively couplable to the first tensioning member 130, such as via a locking mechanism. In the illustrated, non-limiting embodiment, the locking mechanism includes a spring biased first feature 146 complementary to and configured to engage a corresponding second feature 148 arranged at the first tensioning member 130. The first feature 146 may be a tooth or tab biased into a position where the tooth protrudes beyond the distal end 144 of the second tensioning member 134. As shown, a portion of the first feature 146 may be accessible to a user when the belt tensioner 35 is in the locked position. A user may therefore apply a force to the accessible portion causing the first feature 146 to retract toward the distal end 144 and separate from the second feature 148, thereby disengaging the distal end 144 of the second tensioning member 134 from the first tensioning member 130. It should be appreciated that in other embodiments, the feature of the locking mechanism formed at the first tensioning member 130 may alternatively or additionally be movable by the user to selectively unlock the belt tensioner 35.

In an embodiment, the second tensioning member 134 has a tab or engagement member 150 protruding therefrom. Although the engagement member 150 is illustrated as being arranged near the end 136 of the second tensioning member 134, embodiments where the engagement member 150 is arranged at another location of the second tensioning member 134 are also within the scope of the disclosure. When the belt tensioner 35 in a locked configuration, such as when the belt tensioner 35 is positioned within the groove 36, the engagement member 150 is receivable within a corresponding opening 152 formed at a surface of the support base 20 adjacent to and in some embodiments defining the groove 36. In such embodiments, during a locking operation the first tensioning member 130 is pivoted towards the groove 36. Once properly positioned, rotation of the second tensioning member 134 toward the first tensioning member 130 positions the engagement member 150 within the opening 152. The second tensioning member 134 is therefore rotatable like a lever relative to both the first tensioning member 130 and the support base 20. The mechanical advantage of this lever-type configuration reduces the required force applied by a user to transform the belt tensioner 35 to the locked position when a vehicle belt 12 is arranged between the groove 36 and the first tensioning member 130 of the belt tensioner 35.

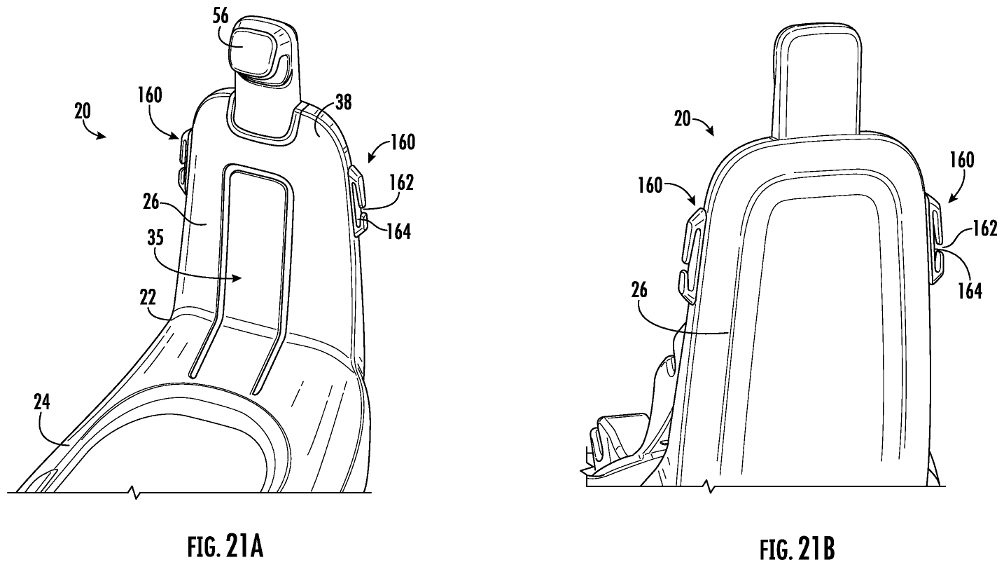

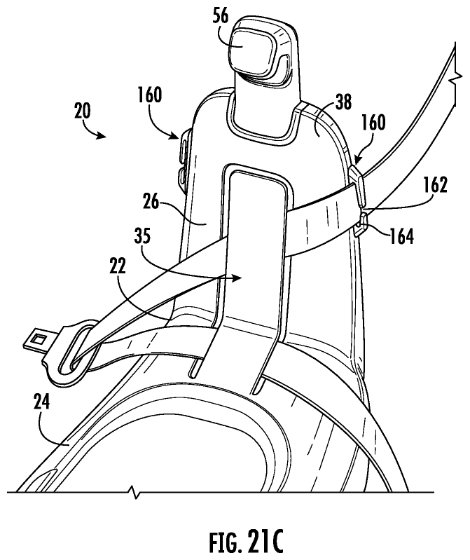

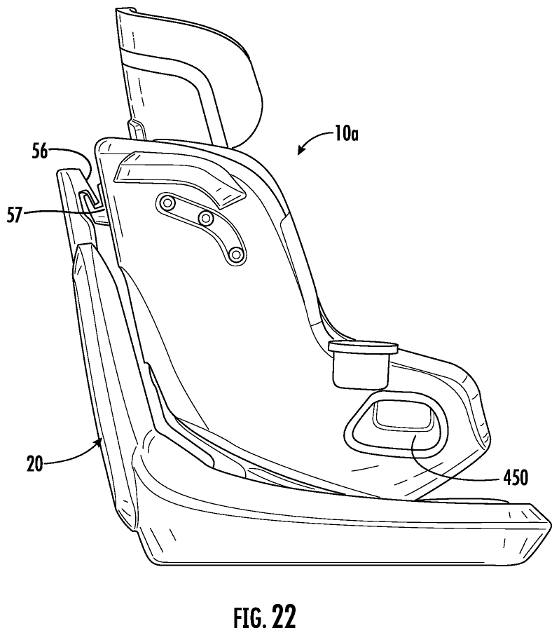

In an embodiment, best shown in FIGS. 21A-21C, one or more belt guides 160 may be positioned about the support base 20, such as the back portion 26 thereof. Although substantially identical belt guides 160 are illustrated as being arranged at opposite sides of the back portion 26, it should be appreciated that embodiments having a single belt guide are within the scope of the disclosure. Further, in embodiments including a plurality of belt guides 160, the belt guides may have varying configurations and/or may be arranged at different vertical and lateral positions based on the vehicle belt path relative to the support base 20. As shown, the belt guide 160 may include a slot 162 connected to an interior opening 164 for receiving a portion of a vehicle belt 12 therein. The at least one belt guide 160 is positioned to maintain the portion of the vehicle belt 12 that is not held in place by the belt tensioner 35 out of the area associated with a seat receivable on the support base 20. The at least one belt guide 160 can also, for example, help align the vehicle belt 12 relative to the support base 20, keep the vehicle belt 12 away from interfering with a base anchor member 56 of the support base, to be described in more detail below, and keep the vehicle belt 12 away from a child when positioned on the child seat 10a, 10b.

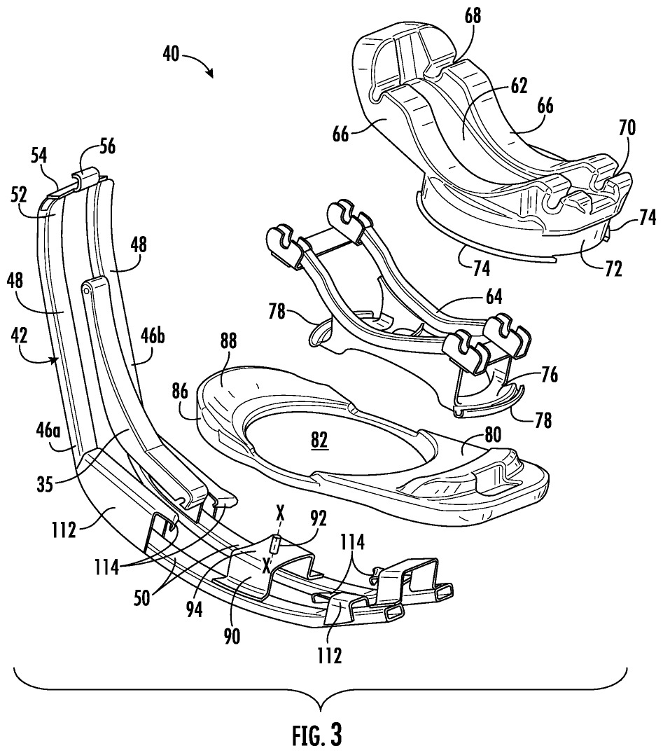

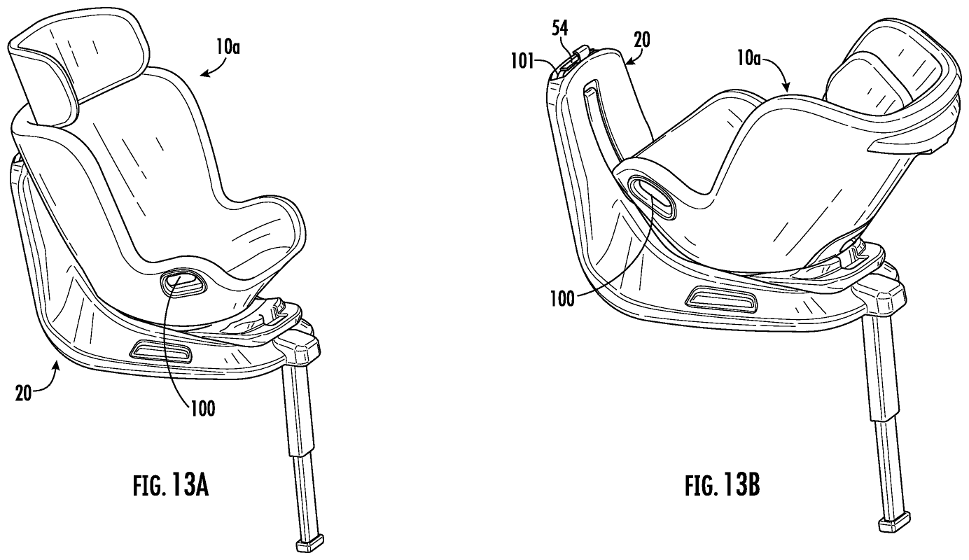

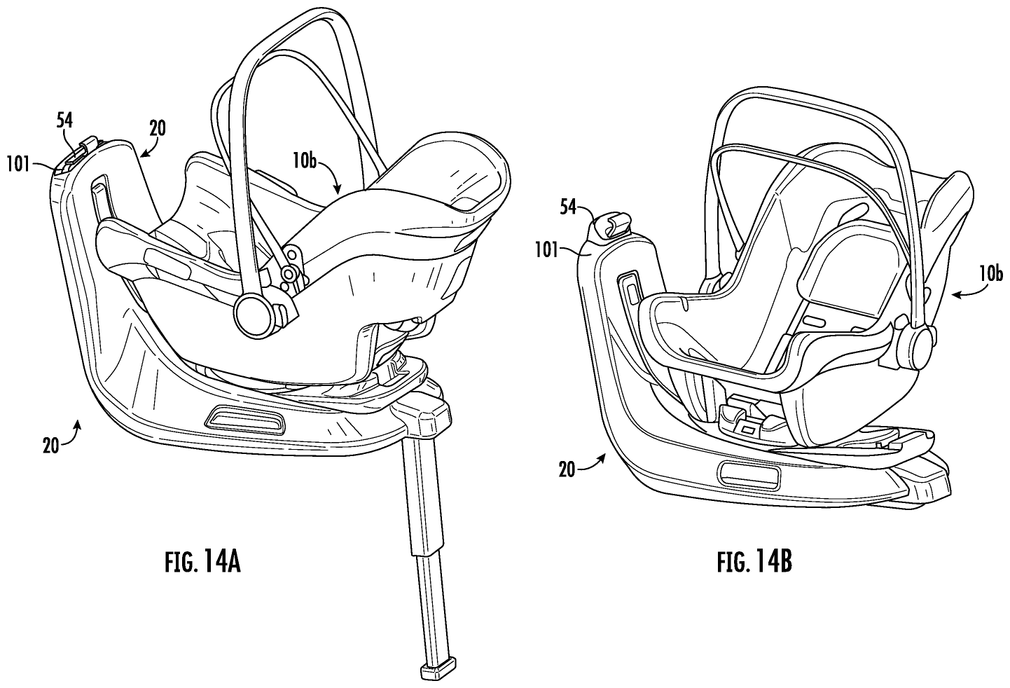

With reference to FIGS. 2 and 3, the support base 20 additionally includes a seat receiving assembly 40 coupled to the base body 22. The seat receiving assembly 40 is configured to receive and couple at least one child seat to the support base 20. In an embodiment, a plurality of child seats are interchangeably mountable to the seat receiving assembly 40. For example, a first child seat 10a (FIGS. 13A-13B) connectable to the seat receiving assembly 40 is a convertible child seat, and a second child seat 10b (FIGS. 14A-14B) connectable to the seat receiving assembly 40 is an infant child seat. As used herein, the term “convertible child seat” refers to a seat that may be used in both a rearward and forward-facing direction such as suitable for use by a child between 5 and 65 pounds, and/or up to 49″ in height. The convertible child seat may also be referred to herein as an upright child seat or a toddler seat. Similarly, as used herein, the term “infant child seat” refers to such a seat as would be defined by one of ordinary skill in the art. For example, an infant child seat may be described as a seat for use by an infant or child too small to use a convertible child seat and may include a carrying handle to allow for portability of the infant child seat external to the vehicle. However, embodiments where another type of child seat is alternatively or additionally connectable to the seat receiving assembly 40 are also contemplated herein.

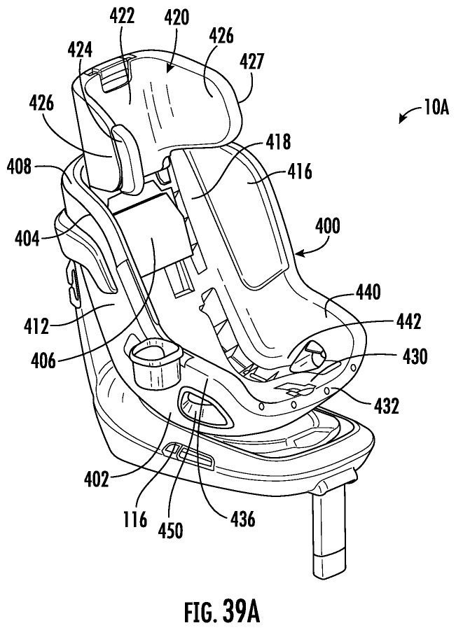

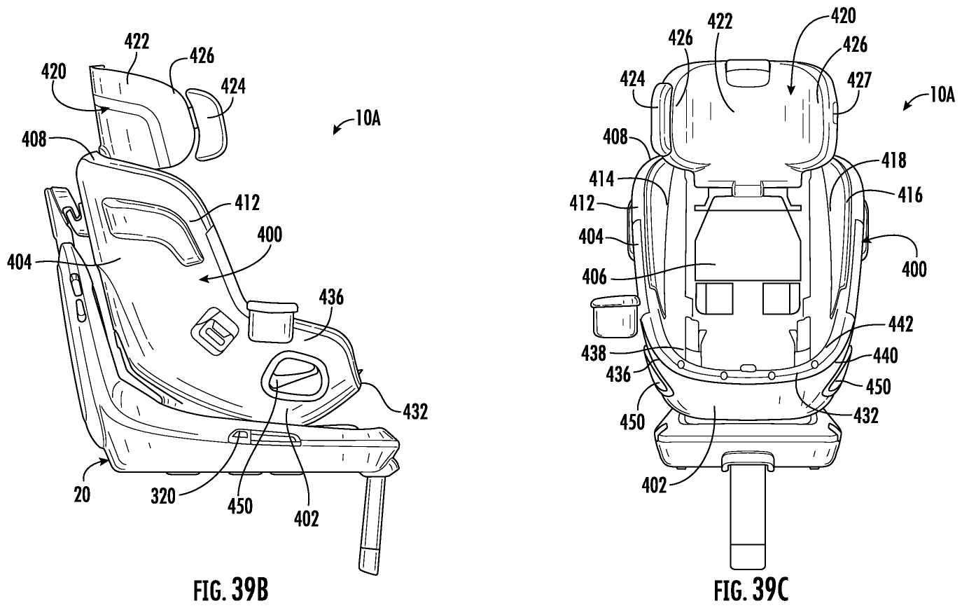

An example of a toddler seat 10a is illustrated in more detail in FIG. 39A-39C. As shown, the toddler seat 10a includes a rigid seat shell 400 adapted to receive a child. The seat shell 400 may include a seat portion 402 and a backrest or upright portion 404 arranged at an angle relative to the seat portion 402. The seat portion 402 and the upright portion 404 may be detachably coupled, or alternatively, may be permanently coupled. In the illustrated, non-limiting embodiment, the upright portion 404 and the seat portion 402 are integrally formed as a single unitary body. In another alternative aspect, the upright portion 404 can be rotationally connected to the seat portion 402 such that the upright portion 404 can incline and recline relative to the seat portion 402.

As shown, the upright portion 404 of the seat shell 400 includes an upright support surface 406 generally facing forward and that extends from a first end or top 408 to a second, opposite end or bottom (not shown) of the upright portion 404. A first upright side member 412 may be arranged at a first side 414 of the upright support surface 406 and a second upright side member 416 may be arranged at a second, opposite side 418 of the upright support surface 406. The first and second upright side members 412, 416 therefore form the left side and the right side of the upright portion 404, respectively. As shown, the first and second upright side members 412, 416 extend forward from the upright support surface 406. The first and second upright side members 412, 416 may extend generally orthogonally to the upright support surface 406, or alternatively, may extend therefrom at another angle, such as an angle greater than 90° for example. Accordingly, the upright support surface 406 and the first and second upright side members 412, 416 define a backrest region or upright support cavity within which an upper body of a child is received.

In the illustrated, non-limiting embodiment, the upright portion 404 of the seat shell 400 includes a headrest 420. The headrest 420 is attached to or integral with the upright portion 404. The headrest 420 may be stationary or in some embodiments, may be configured to move relative to the upright support surface 406. For example, the headrest 420 may be configured to translate relative to the upright support surface 406 between a retracted position and an extended position, allowing for adjustment based on the size of the child positioned within the toddler seat 10a.

With continued reference to FIGS. 39A-39C and further reference to FIG. 40, in an embodiment, the headrest 420 includes a main body, identified at 422, and at least one side impact portion 424 mounted to the main body 422. In the illustrated, non-limiting embodiment, the headrest 420 includes one side impact portion 424 mounted in alignment with and as an extension of the end 426 of the main body 422. The side impact portion 424 can be positioned, for example, on the end 426 closest to a door of the vehicle. However, embodiments including two side impact portions are also contemplated herein. In such embodiments, the side impact portions may be connected to the ends 426 of the main body 422. The side impact portion 424 may be permanently affixed to the main body 422, or alternatively, may be removably couplable thereto. In the illustrated, non-limiting embodiment, a slot 427 (see FIG. 39C) is formed in the main body 422, such as near an end 426 for example, and the side impact portion 424 has a connector 428 receivable within the slot 427 to attached and properly position the side impact portion 424 about the main body 422.

The seat portion 402 includes a seat support surface 430 facing generally upwardly and that extends from a first end or front 432 to a second end or back 434 of the seat portion 402. A first seat side member 436 may be arranged at a first side 438 of the seat support surface 430 and a second seat side member 440 may be arranged at a second, opposite side 442 of the seat support surface 430. The first seat side member 436 and the second seat side member 440 extend upwardly and form the left side and the right side of the seat portion 402. The seat support surface 430 and the first and second seat side member 436, 440 in combination define a region 444 within which at least part of a lower body of a child may be received.

As shown, the seat side members 436, 440 extend at an angle from the seat support surface 430. The angle of the first seat side member 436 relative to the seat support surface 430 may but need not be the same as the angle of the first upright side member 412 relative to the upright support surface 406. Similarly, the angle of the second seat side member 440 relative to the seat support surface 430 may but need not be the same as the angle of the second upright side member 416 relative to the upright support surface 406. In an embodiment, the first upright side member 412 and the first seat side member 436 are integrally formed and the second upright side member 416 and the second seat side member 440 are integrally formed.

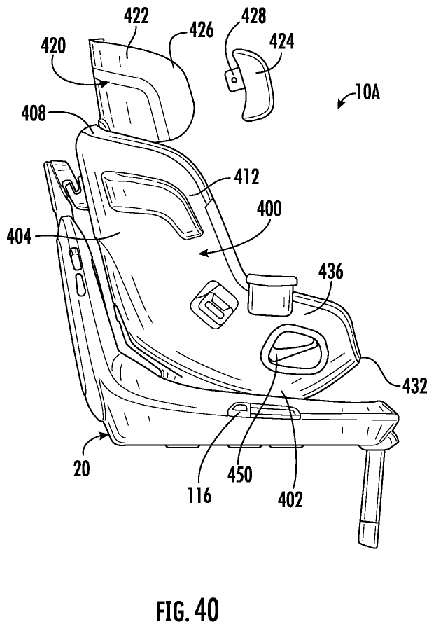

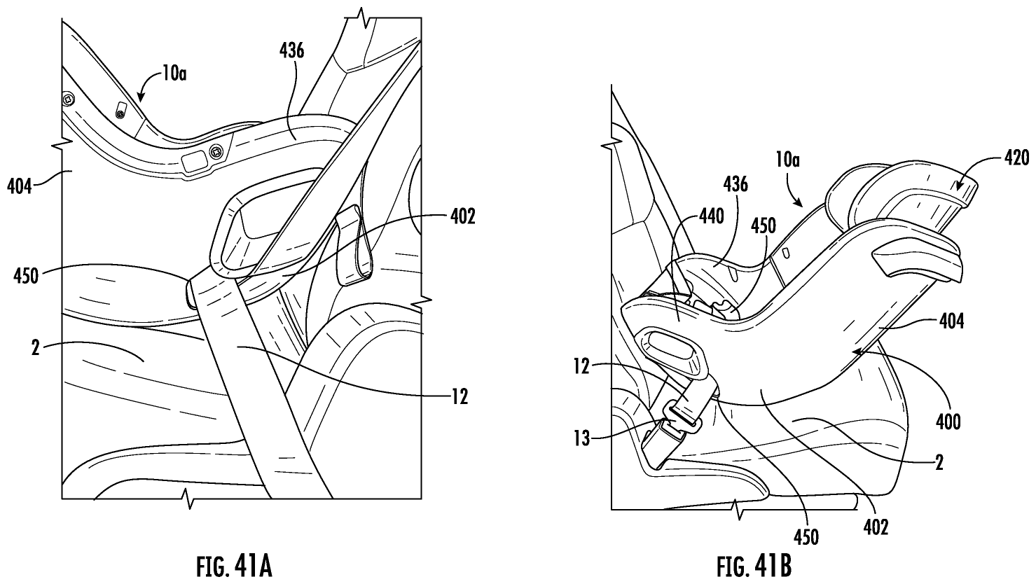

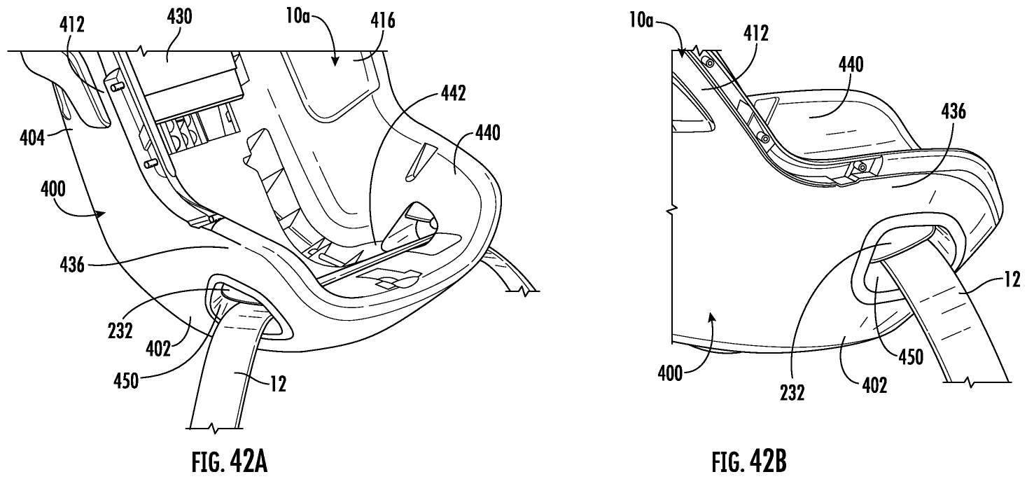

It should be appreciated that although the at least one child seat is illustrated and described herein as being mountable to a vehicle seat 2 via the support base 20, in other embodiments, the child seat may be mountable directly to the vehicle seat 2 absent the support base 20. In such embodiments, the child seat includes one or more openings formed therein and defining a belt path for receiving a vehicle belt 12. For example, with reference to the toddler seat 10a shown in FIGS. 39A-43C, although not shown, each upright side member 412, 416 may have an opening formed therein. Alternatively, or in addition, each of the seat side members 436, 440 may have an opening, such as opening 450 for example, formed therein. Each of these openings may be configured to receive a vehicle belt 12 to secure the toddler seat 10a to a vehicle seat 2 in a forward-facing high-back configuration. It should be appreciated that an infant car seat 10b may have similar openings, such as formed at an upper edge of a seat shell thereof for example, to secure the infant car seat 10b to a vehicle seat 2 in a rearward facing configuration.

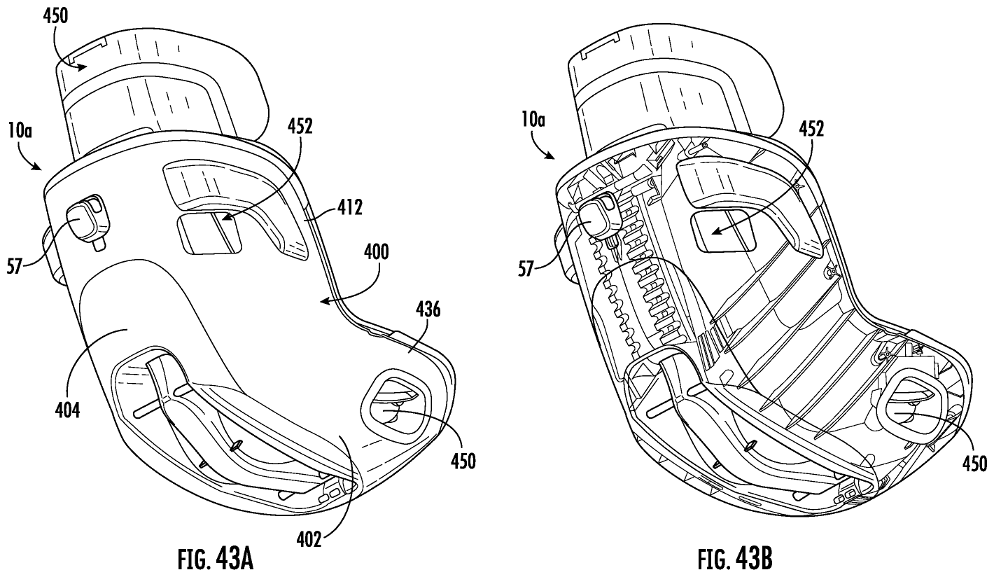

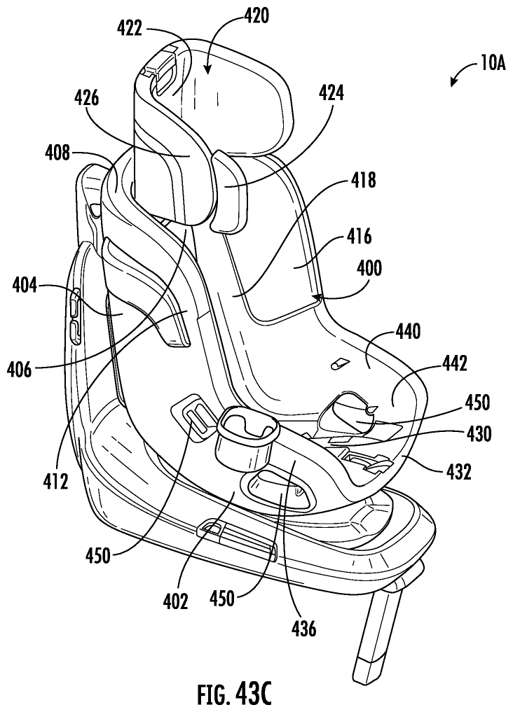

When the vehicle belt 12 is installed along such a vehicle belt path, the normal buckle 13 or connection of the vehicle belt 12 and the tension applied to the belt by a belt tensioner (not shown) may be sufficient to restrict movement of the child seat relative to the vehicle seat 2. Alternatively, or in addition, the child seat may include one or more anchors or latches (not shown) similar to those used in a LATCH system. Examples of a pocket, compartment having a movable cover, or other storage location, identified at 452, for such anchors are illustrated in FIGS. 43A-43C.

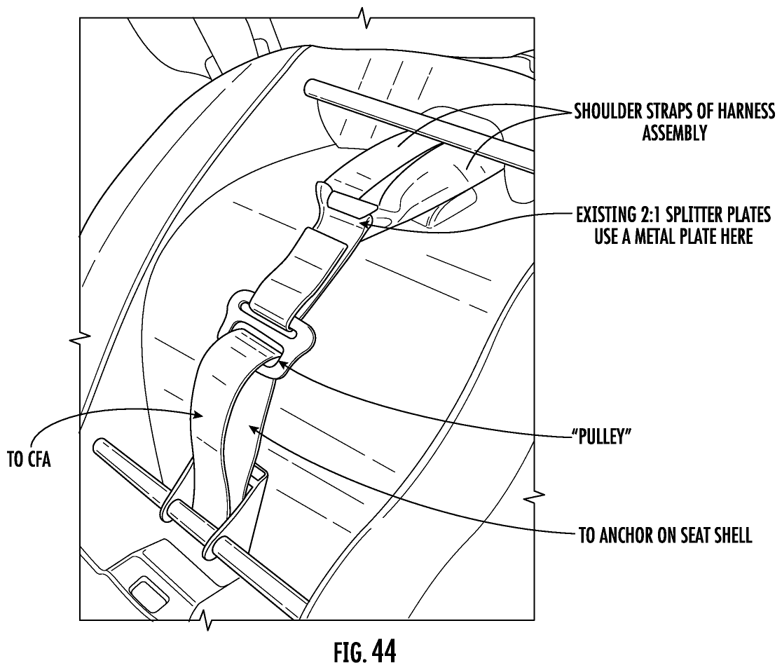

Although generally not shown, the child seat additionally includes a harness assembly for restraining a child within the child seat. Typical harness assemblies include two shoulder straps connectable to at least one crotch strap via a buckle. With reference to FIG. 44, in an embodiment, the two shoulder straps may be anchored to the child seat 10a, 10b via a pulley and a single strap. A sewn splitter may be used to connect the two shoulder straps to the pulley with a piece of webbing. The length of the shoulder straps and the tightness of the harness assembly may be adjusted via the pulley.

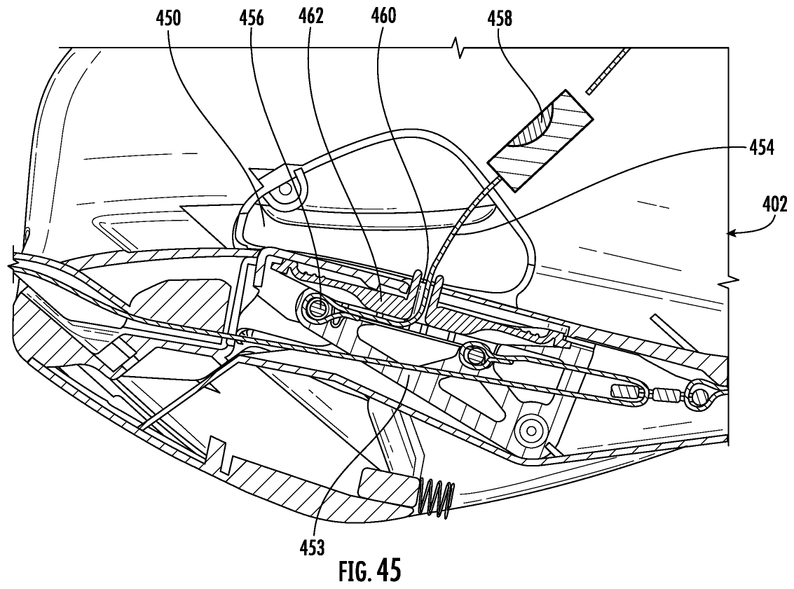

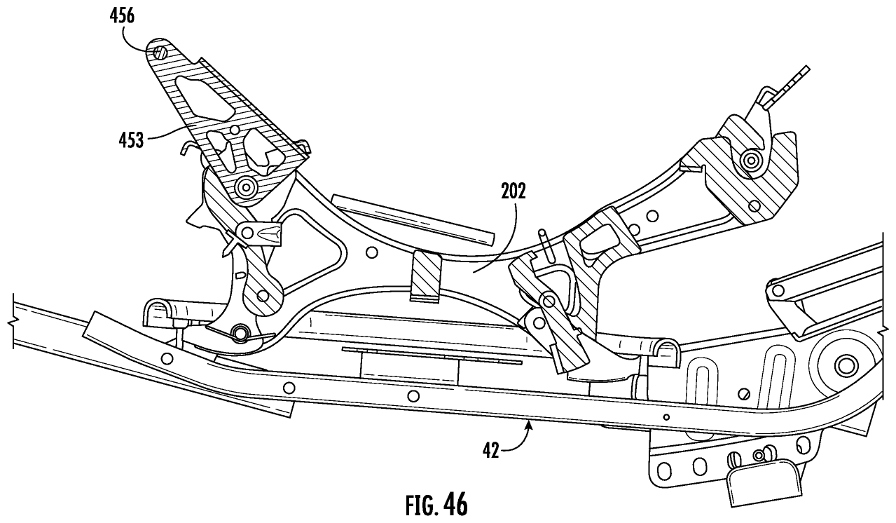

As shown in FIGS. 45 and 46, the toddler seat 10a may include a metal frame 453 arranged within the seat portion 402 of the seat shell 400. When the toddler seat 10a is coupled to the seat attachment 60, the metal frame of the toddler seat 10a may be connected to the metal frame of the attachment member 202 (FIG. 46), which is in turn rigidly connected to the frame of the support base 20. In an embodiment, a crotch strap 454 of the harness assembly is connected to the metal frame 453 of the toddler seat 10a via an anchor pin 456. Such a connection creates a rigid interface between the buckle 458 affixed to the crotch strap and the frame of the support base 20.

In an embodiment, the crotch strap 454 of the harness assembly extends through an opening 460 formed in a slider 462 disposed within the seat portion 402. The slider 462 may be movable forwards and backwards relative to the seat shell 400, such as between a first position and a second position. To move the slider 462, a user applies a force to the slider 462, thereby disengaging the slider from the bottom of the seat portion 402 so that the slider 462 is free to move, for example forwards or backwards. Once properly positioned, the slider 462 can bias into engagement with the seat portion 402. Inclusion of the slider 462 allows the location of the buckle 458 attached to the crotch strap 454 to change based on the size of the child seated within the toddler seat 10a. Although the harness assembly and connection thereof is illustrated and described here with respect to a toddler seat 10a, it should be appreciated that an infant child seat 10b may have a similar harness assembly or may be configured to form a similar rigid connection between the harness assembly and the support base 20.

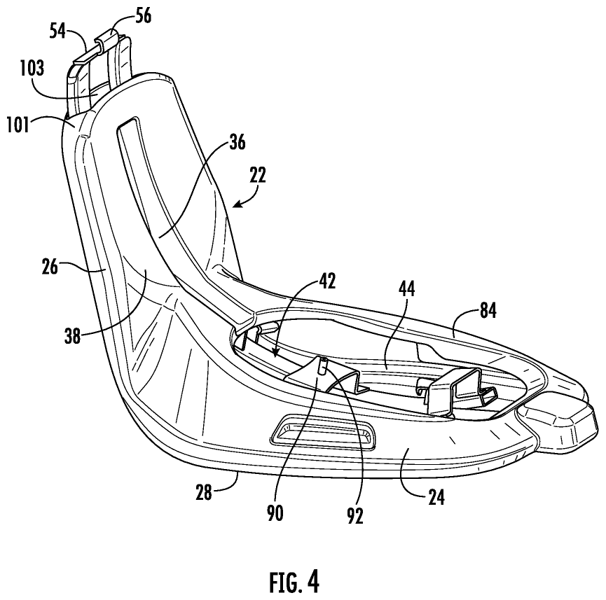

In the illustrated, non-limiting embodiment, the seat receiving assembly 40 includes an incline member 42 generally arranged within the interior 44 of the base body 22 (see FIG. 4). With reference to FIGS. 2-5, the incline member 42 has a first leg 46a and a second leg 46b offset from one another by a distance. Although the first and second legs 46a, 46b are illustrated as being substantially identical, it should be appreciated that in other embodiments, a configuration of the first and second legs 46a, 46b may vary. In the illustrated, non-limiting embodiment, both the first leg 46a and the second leg 46b have an upper portion 48 and a lower portion 50, respectively. The upper portion 48 and the lower portion 50 may be defined by a bend formed in each of the first and second legs 46a, 46b. Accordingly, the upper portion 48 of each of the legs 46a, 46b is arranged at a non-parallel angle relative to the lower portion 50 thereof. The upper portion 48 of each leg 46a, 46b may be arranged within the back portion 26 of the base body 22 and the lower portion 50 of each leg 46a, 46b may be arranged within the seat portion 24 of the base body 22. Because of this positioning, the angle between the upper portion 48 and the lower portion 50 may be identical to, or may be different from, the angle formed between the seat portion 24 and the back portion 26 of the base body 22.

The upper portion 48 of the first and second legs 46a, 46b may have a substantially linear configuration and the lower portion 50 of the first and second legs 46a, 46b may have a generally curved configuration. For example, as shown, the lower portion 50 of the first and second legs 46a, 46b have a generally concave curvature. However, embodiments where the lower portion 50 of the first and second legs 46a, 46b have a different curvature or a linear configuration are also contemplated herein. Further, the distal ends 52 of the upper portion 48 of each leg 46a, 46b may be coupled by a connecting member 54. The connecting member 54 may extend generally perpendicularly or orthogonally to the upper portion 48 of the legs 46a, 46b.

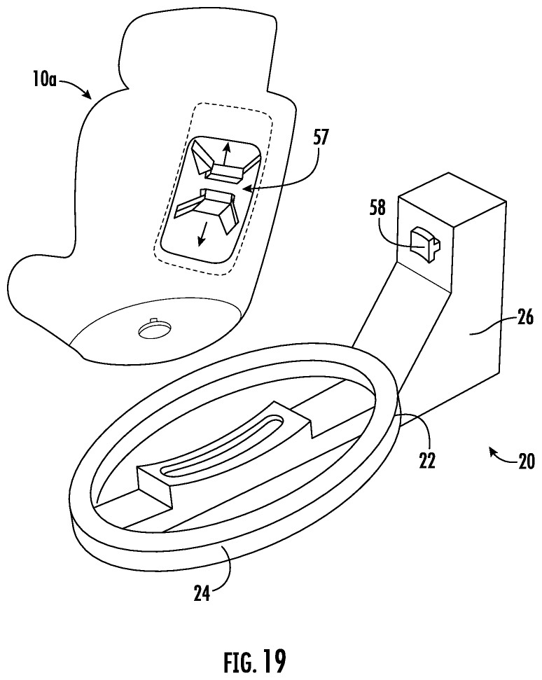

At least one base anchor member 56 may be fixedly connected to the incline member 42. In the illustrated, non-limiting embodiment, a base anchor member 56 is affixed to and protrudes from the connecting member 54 of the incline member 42. The base anchor member 56 is connectable to a corresponding seat anchor member 57 (see FIG. 19 and FIG. 22) of a child seat when the child seat is attached to the seat receiving assembly 40. Such a seat anchor member 57 is typically arranged at a surface of a back portion of a convertible child seat 10a (e.g., located behind the child's back), and therefore the base anchor member 56 is connectable thereto when the child seat is in a forward-facing configuration. This second connection between the base anchor member 56 and the seat anchor member 57 further stabilizes the back portion of the child seat. In such embodiments, the base anchor member 56 may not be connectable to the seat anchor member 57 when the child seat is in a rearward-facing configuration. However, it should be understood that the base anchor member 56 may be suitable for use with a seat anchor member 57 arranged at any location about a child seat.

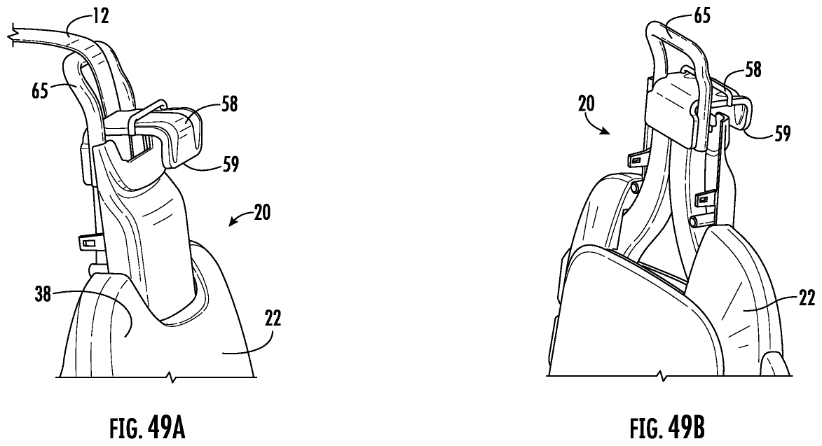

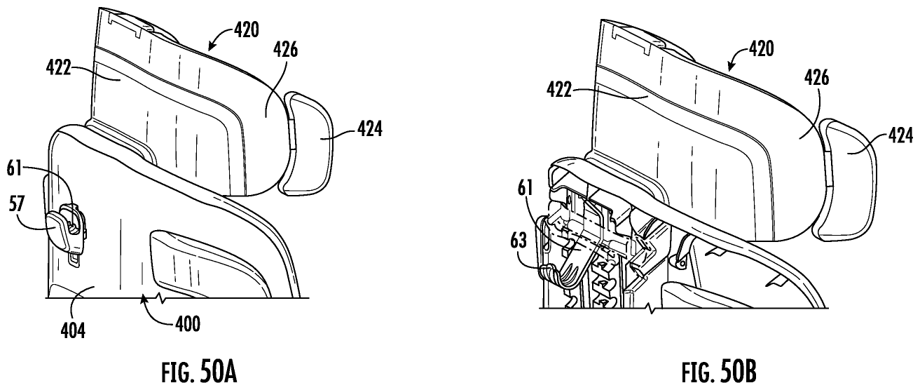

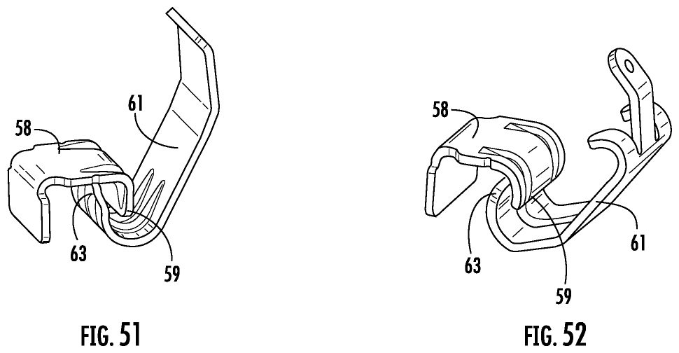

An example of the base anchor member 56 is illustrated in more detail in FIGS. 49A-49B, and an example of the seat anchor member 57 is illustrated in more detail in FIGS. 50A-50B. The base anchor member 56 may include a base top hook 58 having an angular configuration, such as an L or U-shape for example. The base top hook 58 may be formed from any suitably rigid material, such as steel for example. A distal end 59 of the base top hook 58 is offset from the base body 22 such that a gap or clearance is formed therebetween. Similarly, the seat anchor member 57 may include a seat top hook 61 having an angular configuration. Although the seat top hook 61 illustrated in the FIGS. has a generally J-shaped configuration, it should be understood that a seat top hook 61 having any configuration including a distal end 63 receivable within the clearance defined between the distal end 59 of the base top hook 58 and the base body 22 is contemplated herein (see FIGS. 51 and 52).

Alternatively, or in addition, a portion of the base body 22, such as the back portion 26 for example, may include a base anchor member 56 configured to connect to a corresponding seat anchor member (57) of a child seat. In the illustrated, non-limiting embodiment, the base anchor member 56 may be fixedly mounted to the base body 22. The seat anchor member 57 associated with the child seat may be fixed or may be movable about the child seat to accommodate a connection with the base anchor member 56 when the child seat is in multiple positions, such as in a first inclined position and a second inclined position, as will be described in more detail below. Alternatively, base anchor member 56 may be movable about the base body 22, and the seat anchor member 57 may be fixedly mounted to the child seat. The configurations of the seat anchor member 57 and the base anchor member 56 allows the connection between the seat anchor member 57 and the base anchor member 56 to move relative to either one of the child seat and the base body 22 when the child seat transitions between the first inclined position and the second inclined position, as will be described in more detail below.

Alternatively, or in addition, the seat anchor member 57 may be designed with a self-centering feature to facilitate alignment or connection with the base anchor member 56 regardless of the position of the seat anchor member 57 along its path of movement relative to the child seat. In an embodiment, the self-centering feature includes angled contact surfaces configured to engage the base anchor member 56 to center itself relative to the attachment point of the base anchor member 56. As will be described in more detail below, the base anchor member 56 is typically disengaged from a corresponding seat anchor member 57 before the child seat 10 affixed to the seat receiving assembly 40 is rotated about an axis relative to the support base 20.

The support base 20 may additionally include a tether assembly for securing the support base 20 on the vehicle seat 2. The tether assembly includes a tether support 65 movable relative to the base body 22 between a first position and a second position. In an embodiment, the tether support 65 is located at or is integrally formed with the incline member 42, such as an upper end thereof. Accordingly, the tether support 65 may be movable with the incline member 42 relative to the base body 22, as will be described in more detail below. The tether support 65 may be formed from any suitable material, an in the illustrated, non-limiting embodiment has a U-shape with both ends of the tether support 65 connected to the base top hook 58 or directly to a portion of the incline member 42. A tether strap (not shown) is connected to the support base 20 and extends through an opening 67 formed at an upper surface of the base body 22 or of the base anchor member 56 and is connectable to a portion of the vehicle seat 2. When the tether strap is extended through the opening 67 and is connected to the vehicle seat, the tether strap abuts the tether support 65, such that at least a portion of the load acting on the tether strap is transferred to the tether support 65 rather than the base body 22.

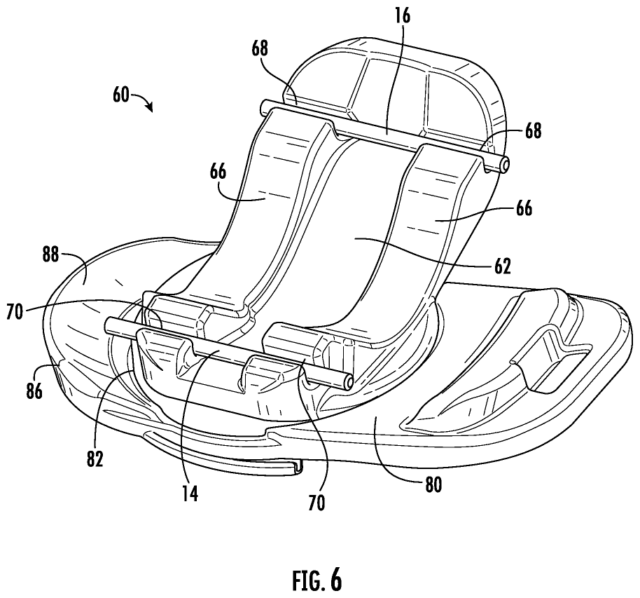

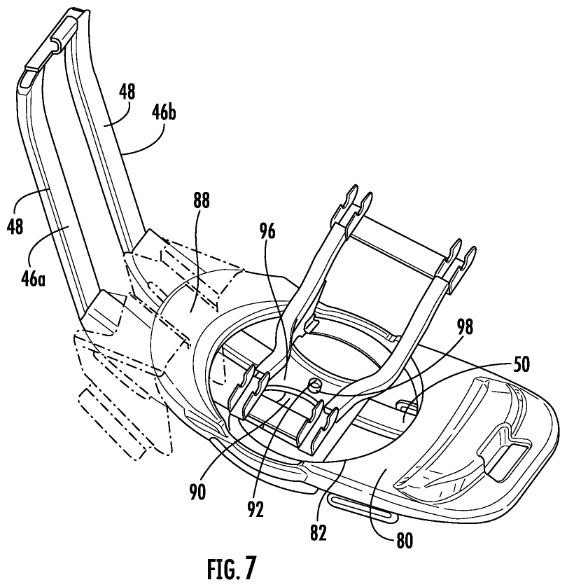

With continued reference to FIGS. 2 and 3 and further reference to FIGS. 6-7, the seat receiving assembly 40 additionally includes a seat attachment 60. In the illustrated, non-limiting embodiment, the seat attachment 60 includes a support platform 62 and an attachment member 64, the support platform 62 being positionable in overlapping arrangement with the attachment member 64. The support platform 62 may include two guide rails 66 that are adapted to receive and couple to a corresponding portion of a child seat 10a, 10b to lock the child seat to the seat attachment 60. The guide rails 66 may be symmetrical and substantially identical as shown. In the illustrated, non-limiting embodiment, each guide rail 66 includes a first groove 68 and a second groove 70 spaced apart from the first groove 68. The first and second grooves 68, 70 can be formed as recesses in the upper surfaces of the guide rails 66 and are sized to receive and hold a part of a component, such as a shaft 14, 16 (FIG. 2) for example, arranged at the bottom or base portion of a child seat 10a, 10b. Although not shown, it should be appreciated that each of the first and second grooves 68, 70 can include a catch with which a corresponding latch (not shown) can engage to lock the child seat 10a, 10b, to the seat attachment 60.

As best shown in FIGS. 2, 3, and 6, an annular or circular collar 72 may protrude from a bottom of the support platform 62. Further, one or more flanges 74 may extend radially outwardly from the distal end of the collar 72. The flanges 74 may but need not extend about the entire periphery of the collar 72. In such embodiments, a base 76 of the attachment member 64 may also include one or more radially outwardly extending flanges 78. Accordingly, when the support platform 62 is mounted in an axially overlapping configuration to the attachment member 64 as shown, the at least one flange 78 of the attachment member 64 is arranged within the plane of the one or more flanges 74 of the collar 72. Further, the flanges 74, 78 may cooperate to form a flange that extends about the entire periphery of the collar 72.

The seat receiving assembly 40 may additionally include a support plate 80 for mounting the seat attachment 60 to the base body 22. As shown, the support plate 80 has a central opening 82 formed therein. The collar 72 of the support platform 62 and the base 76 of the attachment member 64 both extend through the opening 82 such that the flanges 74, 78 abut an underside of the support plate 80. This engagement between the flanges 74, 78 and the support plate 80 may prevent separation of the seat attachment 60 from the support plate 80.

As best shown in FIG. 4, the base body 22 has an opening 84 formed in an upper surface of the seat portion 24. The support plate 80 may be mounted to the base body 22 adjacent to or in overlapping arrangement with the opening 84 (see FIG. 1). For example, in an embodiment, a portion of the support plate 80, such as a first end 86 thereof for example, is receivable within the interior 44 of the base body 22. In the illustrated, non-limiting embodiment, a fin 88 (see FIG. 3) protruding from the support plate 80 near the first end 86 thereof is configured to abut an adjacent surface of the base body 22, such as an interior surface of the seat portion 24 for example, to restrict movement of the support plate 80 relative to the base body 22. In such embodiments, a contour of the fin 88 may be complementary to the contour of the interior surface of the seat portion 24. However, it should be appreciated that embodiments where the support plate 80 is alternatively or additionally connected to the base body 22 in another suitable manner are also within the scope of the disclosure.

When the support plate 80 is installed about the base body 22, the support plate 80 substantially seals the opening 84 of the seat portion 24. Further, the upper surface of the support platform 62 including the guide rails 66 for connecting to a child seat is arranged vertically above the support plate 80, at an exterior of the base body 22.

In an embodiment, the seat attachment 60 is movably coupled to the support base 20, such as to incline member 42. For example, the seat attachment 60 may be rotatably coupled to the incline member 42. Accordingly, the seat attachment 60 may be rotatable relative to the incline member 42, the support plate 80, and the base body 22 between a first rotational configuration, such as a configuration in which a child seat coupled to the seat receiving assembly 40 is in a facing-forward position (FIG. 13A) and a second rotational configuration, such as a configuration in which a child seat coupled to the seat receiving assembly 40 is in a rearward-facing position (FIG. 13B) or one or more other configurations (FIG. 14B).

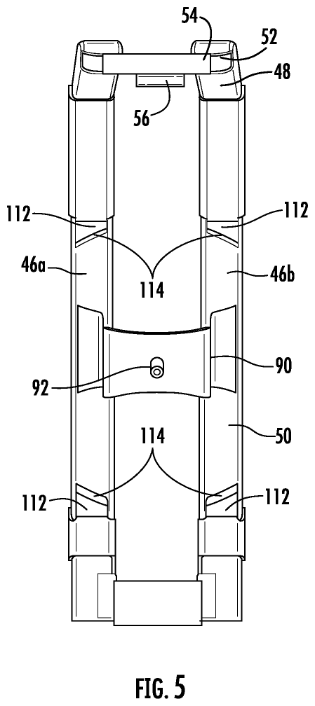

With reference to FIGS. 5, 7 and 8, in the illustrated, non-limiting embodiment, the incline member 42 includes a mounting bracket 90 coupled to the lower portion 50 of one or both of the first leg 46a and the second leg 46b. A mounting post 92 protrudes from an upper surface 94 of the mounting bracket 90. The attachment member 64 may similarly include a plate 96 having an opening 98 formed therein and the mounting post 92 is receivable within the opening 98 to define an axis of rotation X of the seat attachment 60. Accordingly, the coupled support platform 62 and attachment member 64 are rotatable in unison relative to the incline member 42, the support plate 80, and the base body 22 about the axis X.

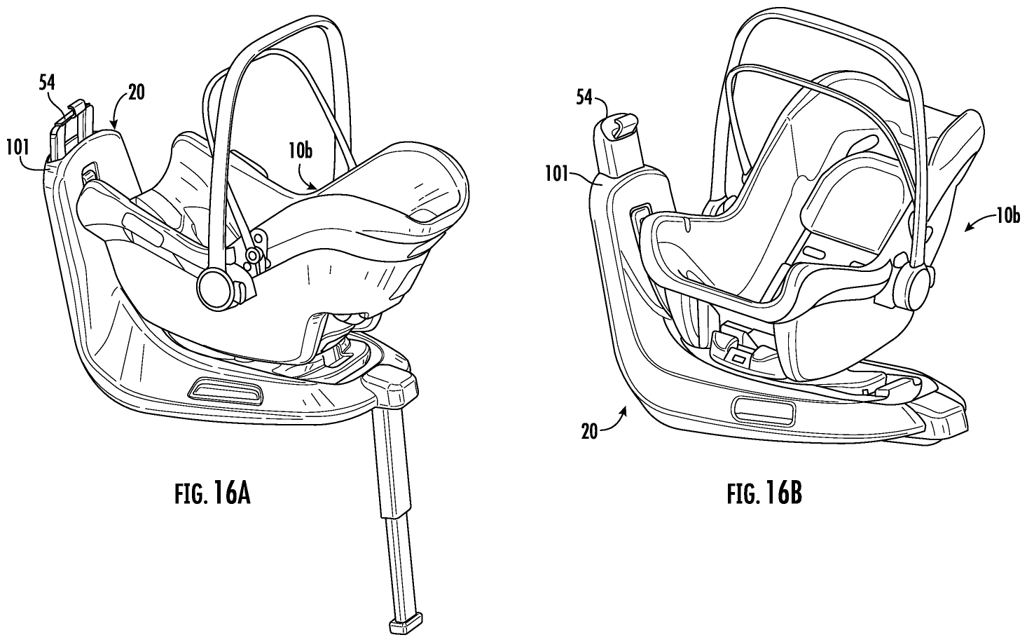

In an embodiment, the allowable rotation of the seat attachment 60 about the axis of rotation X varies based on the child seat connected thereto. For example, when a first child seat, such as a convertible child seat 10a, is coupled to the seat attachment 60, the first child seat 10a is rotatable about the axis X between a first, forward facing configuration (FIG. 13A), and a second, rearward facing configuration (FIG. 13B). The first rotational configuration and the second rotational configuration of the first child seat 10a may be arranged 180 degrees apart. When a second child seat, such as an infant child seat 10b, is attached to the seat attachment 60, the second child seat 10b may be rotatable about the axis of rotation X between a first, rearward facing configuration (FIG. 14B), and a second, side-facing configuration (FIGS. 14B and 16B). The first rotational configuration and the second rotational configuration associated with the second child seat 10b may be arranged about 90 degrees apart, or any amount less than 180 degrees. Accordingly, the allowable rotation of the seat attachment 60 when the first child seat 10a is connected to the seat attachment 60 is greater than the allowable rotation of the seat attachment 60 when the second child seat 10b is connected to the seat attachment 60. However, embodiments where the seat attachment 60 is rotatable in an identical manner when both the first and second child seats 10a, 10b are attached thereto are also contemplated herein.

As previously noted, a child seat such as the first child seat 10a for example, may have a seat anchor member 57 mounted to a back portion thereof. Accordingly, where the child seat is in the first rotational configuration, the seat anchor member is connectable to a base anchor member 56. As the child seat is rotated about the axis relative to the base to the second rotational configuration, the seat anchor member is spaced from the base anchor member 56. Further, as the child seat rotates from the second rotational configuration to the first rotational configuration, the seat anchor member 57 may be configured to automatically align with the base anchor member.

Although not shown, a spin locking mechanism is associated with the seat attachment 60 and is operable to selectively lock the seat attachment 60 in one of a plurality of configurations, including the first rotational configuration and the second rotational configuration. When the spin locking mechanism is engaged, rotation of the seat attachment 60 about the axis of rotation X is restricted. It should be appreciated that the spin locking mechanism may be operable to lock the seat attachment 60, and therefore a child seat coupled thereto, at only the first and second configurations, or alternatively, at any suitable position along the path of rotation between the first rotational configuration and the second rotational configuration.

A spin release actuator 100 may be operable to selectively disengage the spin locking mechanism and therefore allow rotation of the seat attachment 60 about the axis X. In an embodiment, at least a portion of the spin release actuator 100 is located at the child seat connectable to the seat attachment 60 (see FIGS. 13A-13B). However, embodiments where all or at least a portion of the spin release actuator 100 is mounted locally about the support base 20 are also contemplated herein.

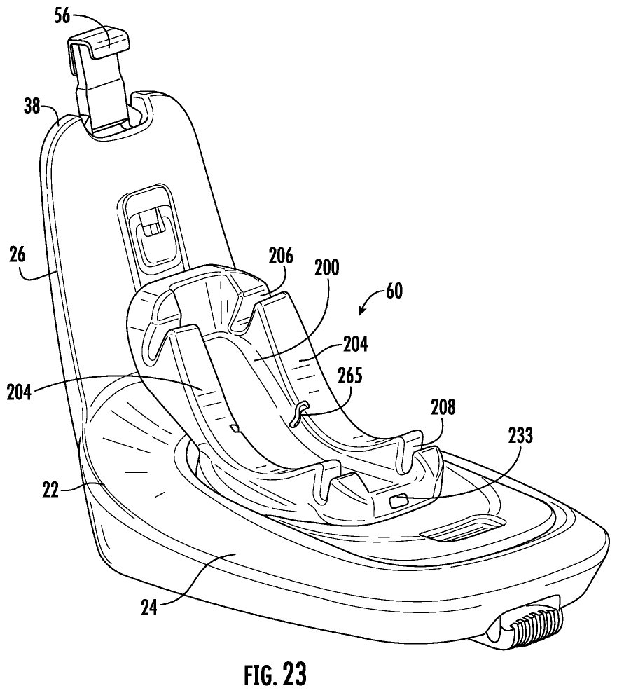

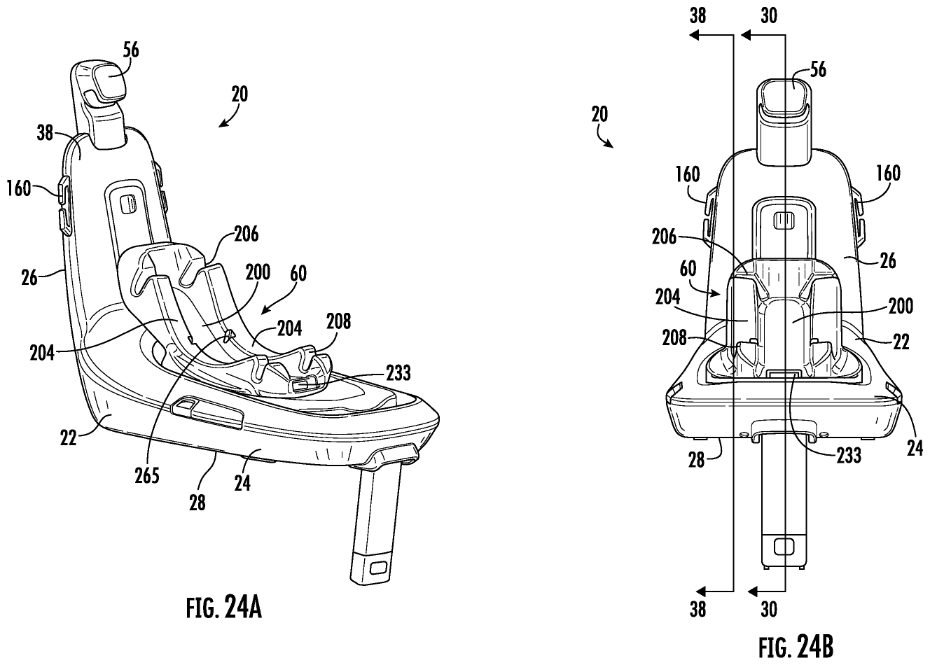

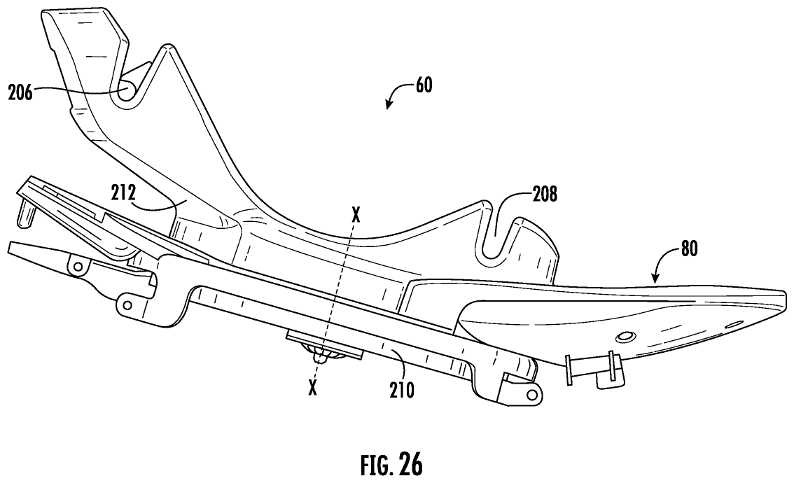

Referring now to FIGS. 23-27, another example of a seat receiving assembly 40 and seat attachment 60 is illustrated. The seat attachment 60 similarly includes a support platform 200 positionable in overlapping arrangement with an attachment member 202 as previously described. The support platform 200 may include one or more guide rails 204 that are adapted to receive and couple to a corresponding portion of a child seat 10a, 10b to lock the child seat to the seat attachment 60. In the illustrated, non-limiting embodiment, each guide rail 204 includes a first groove 206 and a second groove 208 spaced apart from one another. The first and second grooves 206, 208 can be formed as recesses in the upper surfaces of the guide rails 204 sized to receive and hold a part of a child seat, such as a shaft 14, 16. The first and second grooves 206, 208 may include a catch with which a corresponding latch (not shown) can engage to lock the child seat 10a, 10b, to the seat attachment 60.

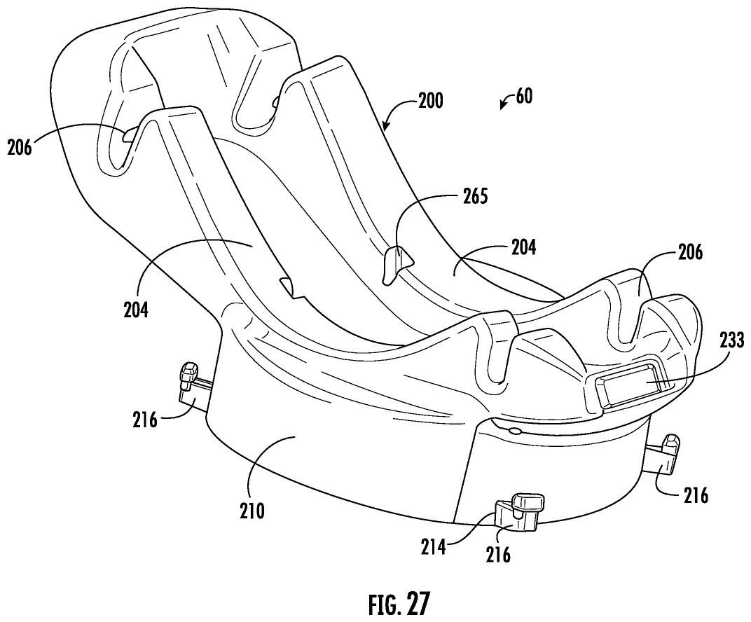

As best shown in FIG. 27, similar to the previous embodiment, an annular or circular collar 210 extends downwardly from a bottom 212 of the support platform 200. In an embodiment, one or more openings 214 are formed in the collar 210. The attachment member 202 may include one or more radially outwardly extending legs 216 and each leg may be receivable within a corresponding opening 214 in the collar 210 to couple the support platform 200 to the attachment member 202. In an embodiment, the attachment member 202 includes a collar 217 with the legs 216 protruding outwardly therefrom. The collar 217 having one or more openings 219 formed therein such that when the support platform 200 is coupled to the attachment member 202, the collar 217 is received within the openings 214 and the collar 210 is received within the openings 219. Accordingly, the support platform 200 and the attachment member 202 in combination may define a collar extending about an entire periphery of the seat attachment 60.

In an embodiment, the bottom of the at least one radially outwardly extending leg 216 is arranged generally flush with a corresponding bottom surface of the collar 210. However, embodiments where the legs 216 are not flush with the bottom surface of the collar 210 are also contemplated herein. In addition, both the collar 210 of the support platform 200 and the legs 216 of the attachment member 202 may extend through the opening 82 formed in a support plate, such as support plate 80.

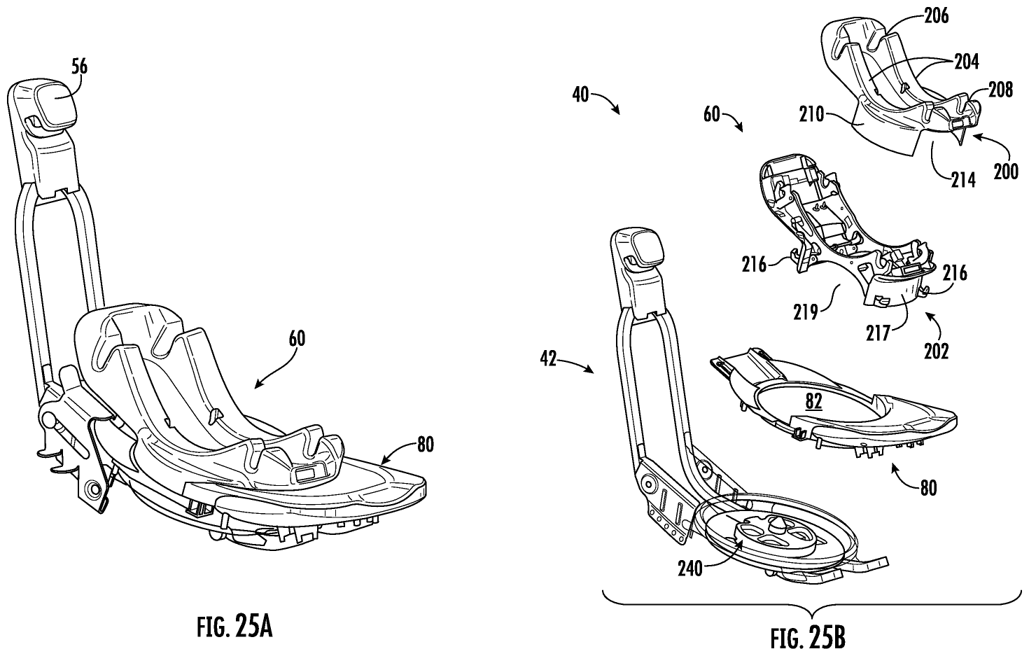

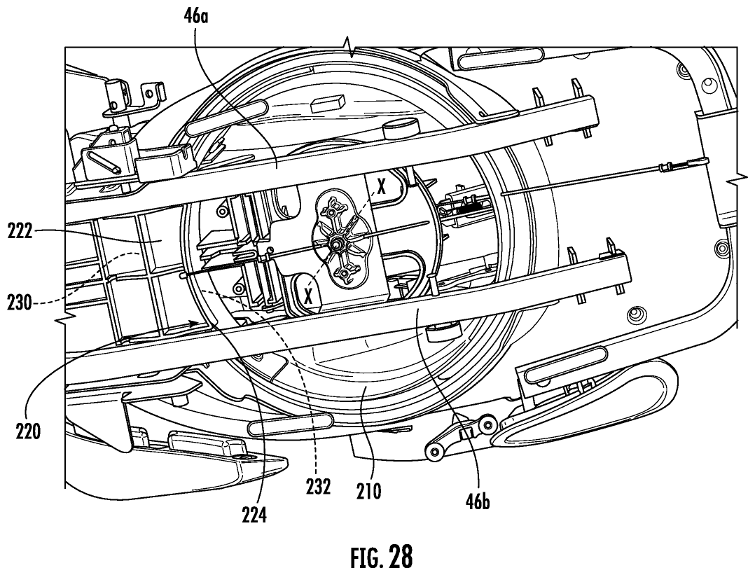

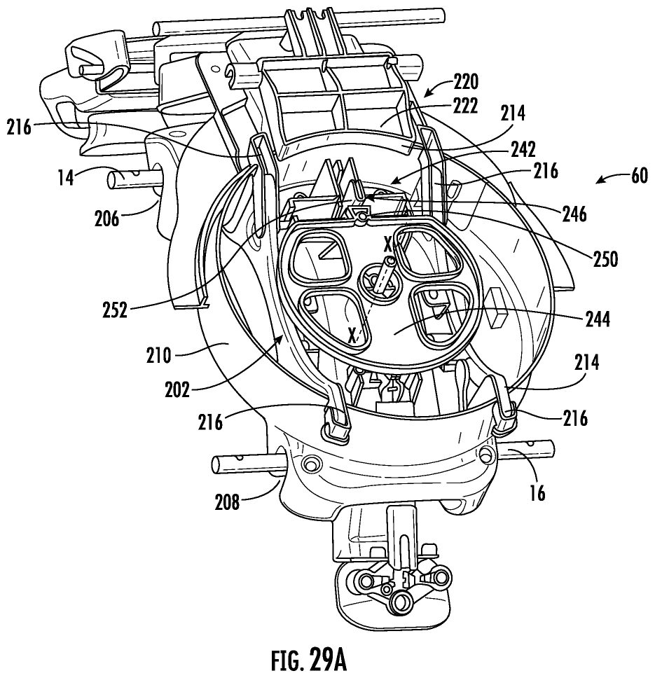

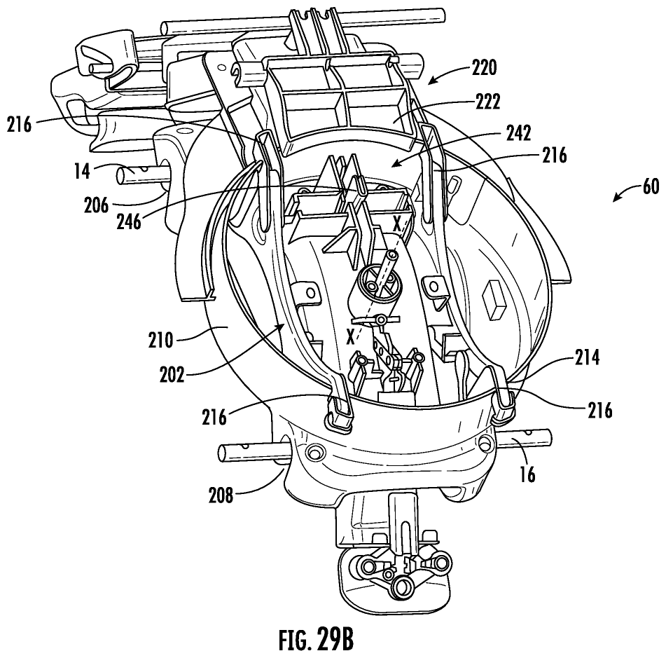

Similar to the previous embodiment, the seat attachment 60 is movably coupled to the support base 20, such as via incline member 42. The seat attachment 60 is rotatable about an axis X relative to the support base 20 between a plurality of rotational configurations including a first rotational configuration and a second rotational configuration. With continued reference to FIGS. 28, 29A and 29B, an example of a lock mechanism 220 operable to selectively restrict movement of the seat attachment 60 about its axis is illustrated. Although the lock mechanism 220 is illustrated and described herein with respect to the seat attachment of FIGS. 25-29B, it should be appreciated that the lock mechanism 220 may be adapted for use with the seat attachment 60 of FIGS. 2, 3, 6, and 7 or another suitable seat attachment.

As shown, the lock mechanism 220 may include a lock member 222 movable, for example translatable along an axis oriented substantially perpendicular to the rotational axis of the seat attachment 60, between a disengaged position and an engaged position. When the lock member 222 is in the engaged position, the spin lock mechanism inhibits rotation of the seat attachment 60. At least one opening 224 (FIG. 28) may be formed in the annular collar 210 of the support platform 200. In the illustrated, non-limiting embodiment, a first opening 224 is formed in the annular collar 210 of the support platform 200 at a first position associated with the first rotational configuration, such as a facing-forward position for example, and a second opening (not shown) is formed in the annular collar 210 at a second or another position associated with the second rotational configuration, such as a rearward-forward position for example. A size and shape of the openings 224 are selected such that at least a portion of the lock member 222 is receivable therein. In some embodiments, the one or more openings are substantially identical in size and/or shape to the portion of the lock member 222 receivable therein.

In the engaged position, best shown in FIG. 28, at least a portion of the lock member 222 extends into an opening 224 formed in the annular collar 210. In this configuration, engagement between a portion of the seat attachment 60, such as a sidewall of the opening 224 for example, and the lock member 222 restricts rotation of the support platform 200, and therefore a child seat attached thereto, about its axis X. Although not shown, a biasing mechanism may be operably coupled to the lock member 222. In such embodiments, the biasing force of the biasing mechanism may be configured to bias the lock member 222 toward the engaged position.

One or more actuators may be operable to transform the lock member 222 to the disengaged position, such as by opposing the bias of the biasing mechanism for example, thereby allowing rotation of the seat attachment 60 about its rotational axis X. In an embodiment, an actuator 230 coupled to the lock member 222 is operable to pull the lock member 222 from the engaged position to the disengaged position. Alternatively, or in addition, an actuator 232 coupled to the lock member 222 is configured to push the lock member 222 from the engaged position to the disengaged position.

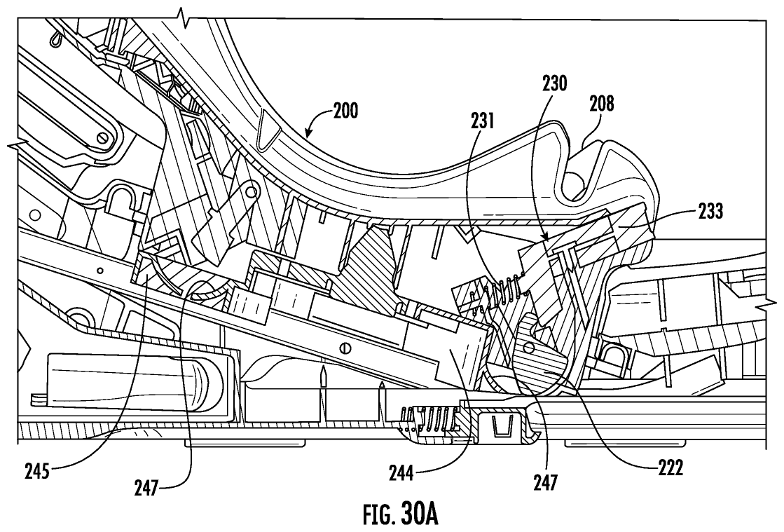

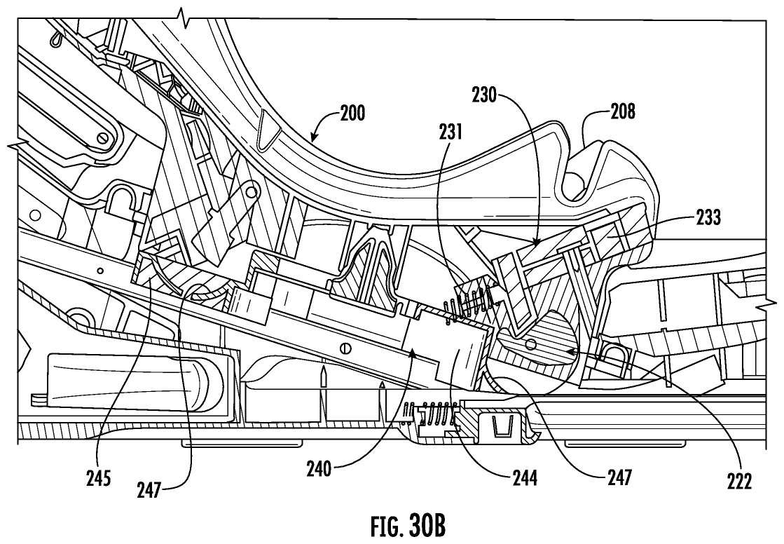

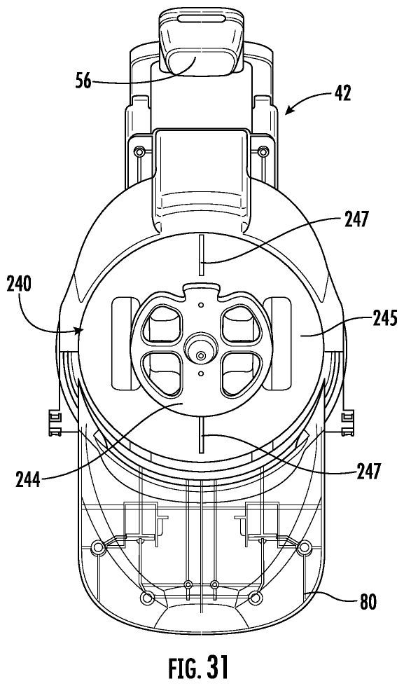

With reference now to FIGS. 30A-30B, a lock mechanism 220 according to another embodiment is illustrated. As shown, the lock member 222 is mounted to the base body 22 and is rotatable about an axis between an engaged or locked position (FIG. 30A) and a disengaged or unlocked position (FIG. 30B). As best shown in FIG. 31, a stationary component, such as a portion of a spin lock-out mechanism 240 (to be described in more detail below) that defines the path of rotation of the seat attachment for example, may be located within the support base 20. In the illustrated, non, limiting embodiment, the spin lock-out mechanism 240 includes a stationary first spin lock member 244 having a radial flange 245 include one or more locking features 247, such as grooves, recesses, or detents for example. When the lock member 222 is in the locked position, a portion of the lock member is receivable within a corresponding locking feature 247. The engagement between the lock member 222 and the locking feature 247 restricts rotation of the seat attachment 60 in any direction about the axis X. When the lock member 222 is in a disengaged position, the lock member 222 is rotated about its axis, out of engagement with the locking feature 247. As a result, the seat attachment 60 is free to rotate relative to the support base 20 to a desired position.

A rotation lock actuator 230 may be operable to transform the lock member 222 to the disengaged position. In the illustrated, non-limiting embodiment, operation of the rotation lock actuator 230 directly applied a force to a portion of the lock member 222, causing the lock member 222 to rotate about its axis. Operation of the rotation lock actuator 230 additionally opposes the bias of the biasing mechanism 231 operably coupled to the rotation lock actuator. Upon release of the actuator, the biasing mechanism 231 will bias the rotational lock actuator 230 out of engagement with the lock member 222. Further, the overall shape and body of the lock member 222 may be selected such that the gravitational force acting on the lock member 222 will cause the lock member to pivot about the axis toward the engaged position when the force of the rotation lock actuator is removed therefrom. It should be appreciated that the various configurations of the lock mechanism 220 illustrated and described herein are intended as an example only and that a lock mechanism 220 having any suitable configuration operable to selectively restrict rotation of the seat attachment is within the scope of the disclosure.

The at least one actuator 230, 232 includes an actuator mechanism 233 accessible by a user to operate the actuator. In the illustrated non-limiting embodiment of FIGS. 23-24B, 27, 30A-30B, and 32B, the actuator mechanism 233 is arranged at the seat attachment 60 and is movable about the axis of rotation X therewith relative to the support base 20. Accordingly, when an infant car seat 10b is connected to the seat attachment 60, a user applies a force to the rotation lock actuator 230 via the actuator mechanism 233 to rotate the seat attachment 60 as desired. In embodiments where a toddler seat 10a is connected to the seat attachment, the toddler seat 10a may cover the actuator mechanism 233. In such embodiments, a spin actuator 251 integral with the toddler seat 10a maybe operably coupled (e.g., via actuator member 235) to the actuator mechanism 233 or to another portion of the actuator 230 such that operation of the spin actuator 251 located on the toddler seat 10a transforms the lock member 222 from a locked position to an unlocked position.

In embodiments including a plurality of actuators 230, 232, the actuation mechanisms of each actuator may be arranged at various locations. For example, an actuation mechanism of a first actuator 230 associated with the lock mechanism 220 may be mounted to the support base 20 and an actuation mechanism of a second actuator 232 associated with the lock mechanism 220 may be located at a child seat 10a, 10b connected to the seat attachment 60. In the non-limiting embodiment shown in FIG. 28, the actuation mechanism of an actuator, such as the second actuator 232 for example, may be disposed at the child seat 10a along the vehicle belt path used to attach the child seat 10a to a vehicle seat 2 directly, without a support base 20.

With reference to FIGS. 5, 7 and 8, in the illustrated, non-limiting embodiment, the incline member 42 includes a mounting bracket 90 coupled to the lower portion 50 of one or both of the first leg 46a and the second leg 46b. A mounting post 92 protrudes from an upper surface 94 of the mounting bracket 90. The attachment member 64 may similarly include a plate 96 having an opening 98 formed therein and the mounting post 92 is receivable within the opening 98 to define an axis of rotation X of the seat attachment 60. Accordingly, the coupled support platform 62 and attachment member 64 are rotatable in unison relative to the incline member 42, the support plate 80, and the base body 22 about the axis X.

In an embodiment, the allowable rotation of the seat attachment 60 about the axis of rotation X varies based on the child seat connected thereto. For example, when a first child seat, such as a convertible child seat 10a, is coupled to the seat attachment 60, the first child seat 10a is rotatable about the axis X between a first, forward facing configuration (FIG. 13A), and a second, rearward facing configuration (FIG. 13B). The first rotational configuration and the second rotational configuration of the first child seat 10a may be arranged 180 degrees apart. When a second child seat, such as an infant child seat 10b, is attached to the seat attachment 60, the second child seat 10b may be rotatable about the axis of rotation X between a first, rearward facing configuration (FIG. 14B), and a second, side-facing configuration (FIGS. 14B and 16B). The first rotational configuration and the second rotational configuration associated with the second child seat 10b may be arranged about 90 degrees apart, or any amount less than 180 degrees. Accordingly, the allowable rotation of the seat attachment 60 when the first child seat 10a is connected to the seat attachment 60 is greater than the allowable rotation of the seat attachment 60 when the second child seat 10b is connected to the seat attachment 60. However, embodiments where the seat attachment 60 is rotatable in an identical manner when both the first and second child seats 10a, 10b are attached thereto are also contemplated herein.

As previously noted, a child seat such as the first child seat 10a for example, may have a seat anchor member 57 mounted to a back portion thereof. Accordingly, where the child seat is in the first rotational configuration, the seat anchor member is connectable to a base anchor member 56 or 58. As the child seat is rotated about the axis relative to the base to the second rotational configuration, the seat anchor member is spaced from the base anchor member 56, 58. Further, as the child seat rotates from the second rotational configuration to the first rotational configuration, the seat anchor member 57 may be configured to automatically align with the base anchor member.

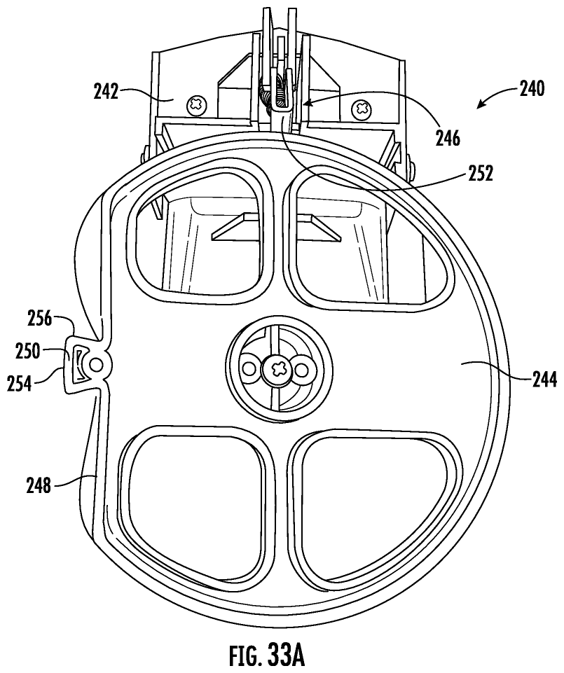

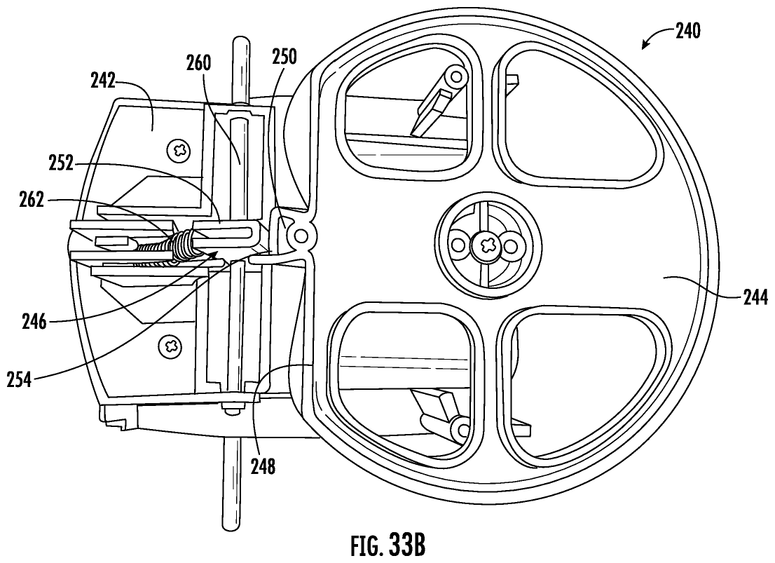

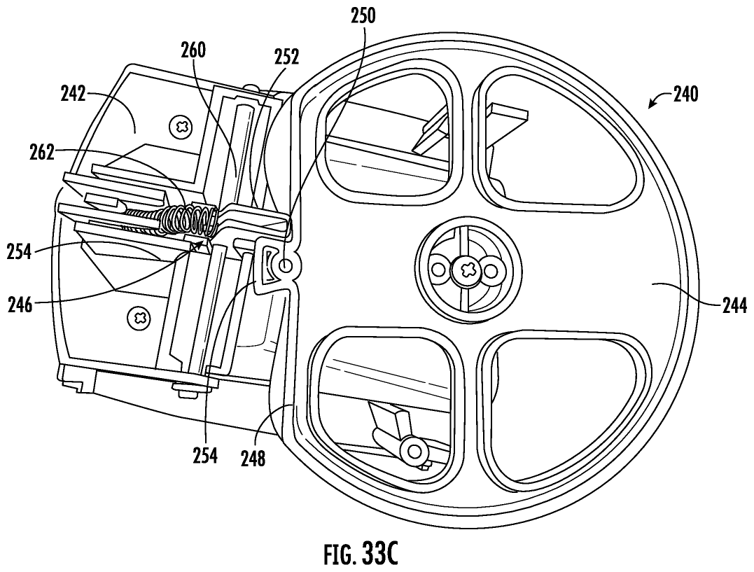

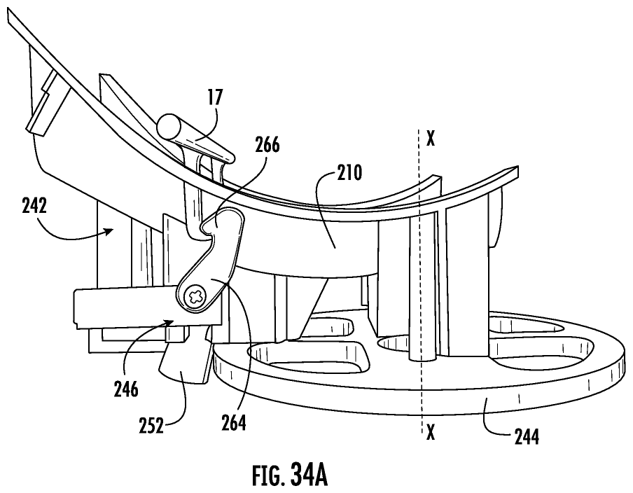

With reference again to FIGS. 28-29B and further reference to FIGS. 33A-33C, an example of a spin lock-out mechanism 240 for defining and/or controlling rotation of the seat attachment 60 about axis X is illustrated. The spin lock-out mechanism 240 may be used to control the allowable rotation of the seat attachment 60 relative to the support base 20 based on the type of child seat 10a, 10b attached thereto. As shown, the spin lock-out mechanism 240 may include a spin carriage assembly 242, a first spin lock member 244, and a second spin lock member 246. The first spin lock member 244 is fixedly mounted relative to the support base 20. In an embodiment, the first spin lock member 244 is integrally formed with or is fixedly mounted to the mounting bracket 90. The spin carriage assembly 242 and the second spin lock member 246 are rotatable with the seat attachment 60. In the illustrated, non-limiting embodiment, the spin carriage assembly 242 is integrally formed with an underside of the support platform 200. Accordingly, in some embodiments, the annular collar 210 of the support platform 200 may be considered the spin carriage assembly 242. The second spin lock member 246 may be movably coupled to a portion of the seat attachment 60, such as to the spin carriage assembly 242 for example. Accordingly, the spin carriage assembly 242 and the second spin lock member 246 are rotatable with a child seat 10a, 10b attached to the seat attachment 60 relative to the first spin lock member 244.

As shown, the first spin lock member 244 may have a partially circular periphery. For example, the first spin lock member 244 may have a constant radius about at least 200 degrees thereof, and in some embodiments about at least 220 degrees, at least 240 degrees, at least 250 degrees, at least 260 degrees and at least 270 degrees. The remaining portion of the periphery of the first spin lock member 244 has a reduced radius. In an embodiment, a chord portion 248 extends between the two end points of the circular periphery having a constant radius and a protrusion 250 extends radially outwardly from the chord portion 248, such as from a central location of the chord portion 248 for example. However, the radius at the protrusion 250 is less than the constant radius. In an embodiment, the chord portion 248 has a curved configuration such that the radius of the chord portion 248 gradually decreases from each of the two end points of the circular periphery towards the protrusion 250.

As the spin carriage assembly 242 and the second spin lock member 246 rotate with the seat attachment 60 about the rotational axis X, the second spin lock member 246 is generally engaged with the outer periphery of the first spin lock member 244. In embodiments where a first child seat 10a, such as a convertible child seat or toddler seat for example, is connected to the seat attachment 60, the spin carriage assembly 242 and the second spin lock member 246 may be arranged in a free configuration. In a free configuration, the spin carriage assembly 242 and the second spin lock member 246 are free to rotate 360 degrees about the entire periphery of the first spin lock member 244. In embodiments where a second child seat 10b, such as an infant child seat for example, is coupled to the seat attachment, the second spin lock member 246 may be considered to be arranged in a lockable configuration. During rotation of the spin carriage assembly 242 and the second spin lock member 246 in the lockable configuration, the engagement member 252 is configured to abut a side surface 256 of the protrusion 250. As a result, the interference between the engagement member 252 and the side surface 256 of the protrusion 250 limits rotation of the second spin lock member 246 to less than 360 degrees. In an embodiment, the contact between the engagement member 252 and a side surface 256 of the protrusion 250 restricts rotation of the seat attachment 60 to a forward-facing position.

In the illustrated, non-limiting embodiment, the engagement member 252 of the second spin lock member 246 is fixedly mounted to a shaft 260. The shaft 260 is rotatable about a longitudinal axis thereof between a locked position and an unlocked position. A biasing mechanism 262, such as a coil spring for example, may be fixedly mounted to the engagement member 252 or to another portion of the second spin lock member 246. A biasing force of the biasing mechanism 262 may be configured to bias the shaft 260 about its axis toward the locked position.

When the engagement member 252 of the second spin lock member 246 is arranged in contact with the circular periphery of the first spin lock member 244 having a constant radius, regardless of whether a first child seat 10a or a second child seat 10b is connected to the seat attachment 60, the contact between the engagement member 252 of the second spin lock member 246 and the first spin lock member 244 opposes the biasing force of the biasing mechanism 262. Accordingly, when the engagement member 252 of the second spin lock member 246 is in contact with the circular periphery of the first spin lock member 244 having a constant radius, the shaft 260 is retained in the unlocked position.

As the second spin lock member 246 rotates further about the axis X relative to the first spin lock member 244, the engagement member 252 contacts the periphery of the chord portion 248 in a direction towards the protrusion 250. Because the radius at the chord portion 248 gradually reduces from an end point thereof towards the protrusion 250, the force acting on the engagement member 252 by the first spin lock member 244 and opposing the biasing force of the biasing mechanism 262 decreases. As a result, the biasing force of the biasing mechanism 262 will cause the shaft 260 and the engagement member 252 coupled thereto to rotate about the shaft axis to maintain contact between the engagement member 252 and the first spin lock member 244.

When the first child seat 10a is connected to the seat attachment 60, the first child seat 10a may be configured to oppose the biasing force of the biasing mechanism 262, thereby preventing the second spin lock member 246 from transitioning to the lockable configuration from the free configuration. As shown, the engagement member 252 is positioned radially outward of the protrusion 250 in the free configuration. As a result of this positioning, the second spin lock member 246 is freely rotatable about the entire periphery of the first spin lock member 244.

In an embodiment, at least one removal lock member 264 is affixed to the shaft 260 of the second spin lock member 246, such as at an exterior of the spin carriage assembly 242 for example. Accordingly, the at least one removal lock member 264 is configured to rotate with the shaft 260 and the engagement member 252 about the shaft axis between the locked position and the unlocked position. The first child seat 10a may include not only shafts 14 and 16 arranged at the bottom thereof as previously described, but also an additional intermediate shaft 17, such as positioned between shafts 14, 16. In such embodiments, a corresponding opening 265 (see FIG. 27) may be formed in the seat attachment 60 for receiving the intermediate shaft 17.

When the first child seat 10a is coupled to the seat attachment 60, the intermediate shaft 17 of the first child seat 10a is arranged within a path of rotation of the at least one removal lock member 264 of the second spin lock member 246. Accordingly, as the engagement member 252 rotates from an end point of the chord portion 248 towards the protrusion 250, engagement between the intermediate shaft 17 and the at least one removal lock member 264 coupled to the shaft 260 opposes the biasing force of the biasing mechanism 262. This engagement restricts further rotation of the shaft 260, thereby preventing the second spin lock member 246 from transitioning from the free configuration to the lockable configuration.

The second child seat 10b does not include a comparable intermediate shaft. Accordingly, when the second child seat 10b is connected to the seat attachment 60, as the engagement member 252 rotates from an end point of the chord portion 248 towards the protrusion 250, the shaft 260 of the second spin lock member 246 is biased by the biasing force of the biasing mechanism 262 to the lockable configuration. In the lockable configuration, the engagement member 252 is biased inwardly towards a surface of the first spin lock member 244. In this first, lockable configuration, the protrusion 250 of the first spin lock member 244 is arranged within the path of rotation of the engagement member 252 of the second spin lock member 246, thereby restricting rotation of the second spin lock member 246, the spin carriage assembly 242, and the seat attachment 60 (including the second child seat 10b) to one or more positions, such as a forward-facing position. It should be appreciated that the spin lock-out mechanism 240 illustrated and described herein is intended as an example only and that any suitable mechanism for controlling the rotation of a seat attachment 60 about an axis based on the child seat affixed thereto is within the scope of the disclosure.

In an embodiment, separation of the first child seat 10a from the seat attachment 60 is restricted based on a position of the first child seat 10a relative to the support base 20. For example, the first child seat 10a may be separable from the seat attachment when the first child seat 10a is arranged at any position relative to the support base 20 except at a specific position, such as when in a forward-facing configuration. In the forward-facing configuration, separation of the first child seat 10a from the seat attachment 60 may be prevented by the at least one removal lock member 264. As previously described, in a forward-facing configuration, the base anchor member 56 of the first child seat 10a is connected with a corresponding seat anchor member 57 of the support base 20. Accordingly, separation of the first child seat 10a from the support base 20 when coupled with the support base 20 in the forward-facing configuration is prevented by locking the at least one removal lock member 264 to the intermediate shaft 17 of the first child seat 10a.

In an embodiment, the at least one removal lock member 264 is operable to selectively restrict separation of the first child seat 10a from the seat attachment 60. The second spin lock member 246 is able to freely rotate about the first spin lock member 244 when a first child seat 10a is coupled thereto. During this rotation, as previously described, the engagement member 252 is arranged radially outward of or is configured to contact a radially peripheral surface 254 of the protrusion 250 of the first spin lock member 244. As best shown in FIG. 33A, when the first child seat 10a is arranged at any position other than the specific position at which separation is restricted, the shaft 260 and therefore the at least one removal lock member 264 are in an unlocked position. In an embodiment, when the spin carriage assembly 242 and engagement member 252 of the second spin lock member 246 are rotated to the chord portion 248 of the first spin lock member 244 towards the protrusion 250, the biasing force of the biasing mechanism 262 rotates the at least one removal lock member 264 from the unlocked position at least partially towards the locked position. This rotation of the at least one removal lock member 264 may be caused by the reduced radius of the first spin lock member 244 and the resulting separation in contact between the engagement member 252 and the first spin lock member 244.

In the illustrated, non-limiting embodiment, the at least one removal lock member 264 includes a hook or other engagement feature 266 arranged at the distal end thereof. As the at least one removal lock member 264 rotates towards the locked position, such as due to the reduced radius as the chord portion 248 of the first spin lock member 244 for example, the hook 266 engages the intermediate shaft 17 or a corresponding portion associated with the intermediate shaft 17 of the first child seat 10a (best shown in FIG. 33B). As a result of this engagement, the first child seat 10a is inseparable from the seat attachment 60 when the engagement member 252 of the second spin lock member 246 is rotated to the chord portion 248 of the first spin lock member 244, such as when the first child seat 10a is in the forward-facing position. Similarly, as the first child seat 10a connected to the seat attachment 60 rotates away from the forward-facing position, the first child seat 10a may be considered to be in the second rotational configuration as soon as the engagement feature 266 disengages or separates from the first child seat 10a. Although the at least one removal lock member 264 is illustrated and described herein as being operable to prevent separation of the first child seat 10a from the seat attachment 60 when in the forward-facing position, it should be appreciated that seat attachment 60 may be designed to prevent separation of the first child seat 10a therefrom at an alternative or additional position relative to the support base 20.

With reference again to FIG. 1A-5, in an embodiment, the incline member 42 is movable, for example translatable, relative to the base body 22 between a first position, such as a reclined position, and a second position, such as an inclined position. However, it should be appreciated that the first position and the second position may both be positions arranged at an incline, the positions having varying degrees of incline. In the illustrated, non-limiting embodiment, the connecting member 54 of the incline member 42 is arranged generally adjacent to or flush with the upper end 101 of the back portion 26 of the base body 22 when in the first position. Similarly, when in the second position, the incline member 42 protrudes through an opening 103 formed at the upper end 101 of the back portion 26 such that the connecting member 54 is spaced from the end of the back portion 26 by a distance.

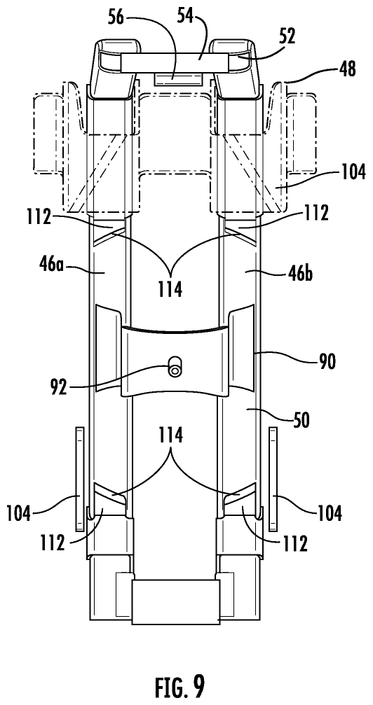

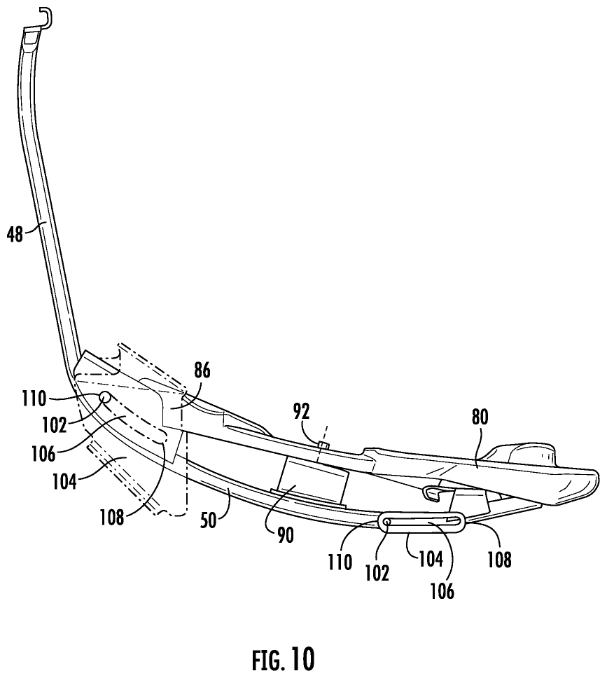

With reference to FIGS. 9 and 10, in the illustrated, non-limiting embodiment, the incline member 42 includes a frame having one or more legs 46. As shown, at least one of a first leg 46a and a second leg 46b of the incline member 42 has one or more pins 102 protruding outwardly therefrom. Although two pins 102 (FIG. 10) are shown protruding from each leg 46a, 46b (a central portion and an end), it should be appreciated that embodiments having only a single pin or more than two pins are also within the scope of the disclosure. Further, although each of the pins 102 is illustrated as being arranged at the lower portion 50 of each leg 46a, 46b arranged within the seat portion 24 of the base body 22, in other embodiments, one or all of the pins 102 may extend from the upper portion 48 of the legs 46a, 46b.

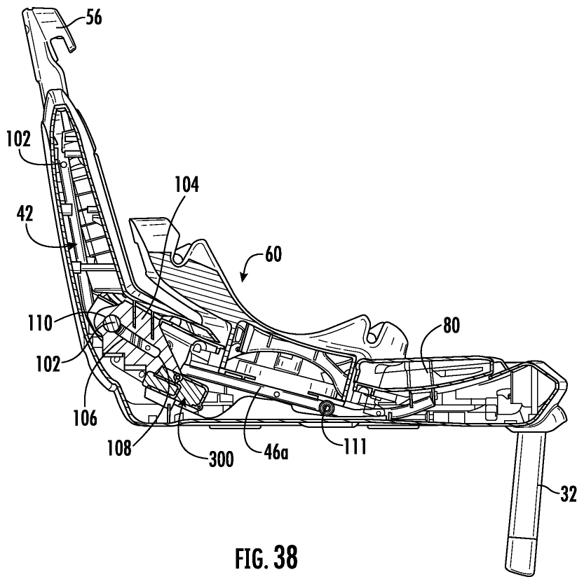

For example, with reference to the embodiment of the incline member 42 illustrated in FIG. 38, the incline member 42 is slidably connected to the support base 20 at a plurality of distinct locations. A first sliding pin connection may be arranged near the upper end of the back portion 26 of the support base 20 and a second sliding pin connection may be arranged near a central portion of the support base 20, such as near the interface between the seat portion 24 and the back portion 26 of the base body 22. In an embodiment, a roller 111 may be mounted at or near an end of the incline member 42 near the stability leg 32. In such embodiments, the roller 111 may be configured to roll along or engage a ramp or track portion located at an adjacent surface of the base body 22.

A plurality of movement brackets 104 are arranged within the interior 44 of the base body 22, such as adjacent to a surface of at least one of the legs 46a, 46b. The movement brackets 104 may be fixed to the base body 22. Although the brackets 104 are illustrated as separate components positioned within the interior 44 of the base body 22, it should be appreciated that the embodiments where the movement brackets 104 are integrally formed with the base body 22 are also contemplated herein. The movement brackets 104 may have at least one elongated slot 106 formed therein, and a corresponding pin 102 of the incline member 42 is receivable within each slot 106. The position of the pin 102 within the slot 106 allows a force applied by the vehicle belt 12 to the base body 22 to be directly transferred to the incline member 42. The slots 106 define a path of movement of the incline member 42 relative to the base body 22. Accordingly, in the illustrated, non-limiting embodiment, the incline member 42 is in the first or reclined position when the pins 102 are positioned adjacent to a first end 108 of each of the slots 106, and the incline member 42 is in the second or inclined position when the pins 102 are positioned adjacent to a second, opposite end 110 of each of the slots 106.

It should be understood that the pin and slot engagement described herein is intended as an example only and that any configuration that allows movement of the seat receiving assembly 40 relative to the base body 22 is within the scope of the disclosure. For example, in an embodiment, the legs 46a, 46b of the incline member 42 have one or more rollers configured to engage a curved surface of the base body 22 or of a component arranged within the interior 44 of the base body 22.

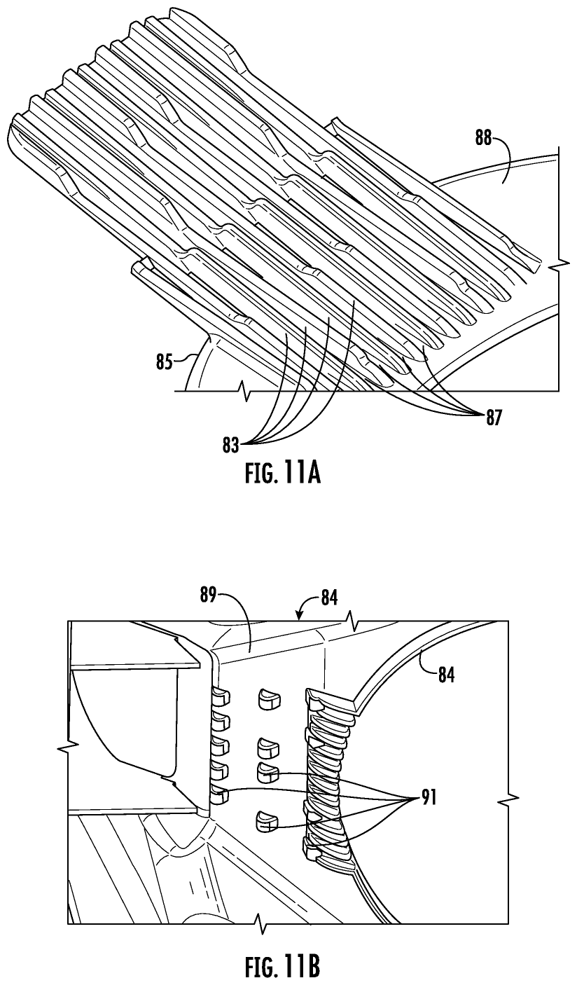

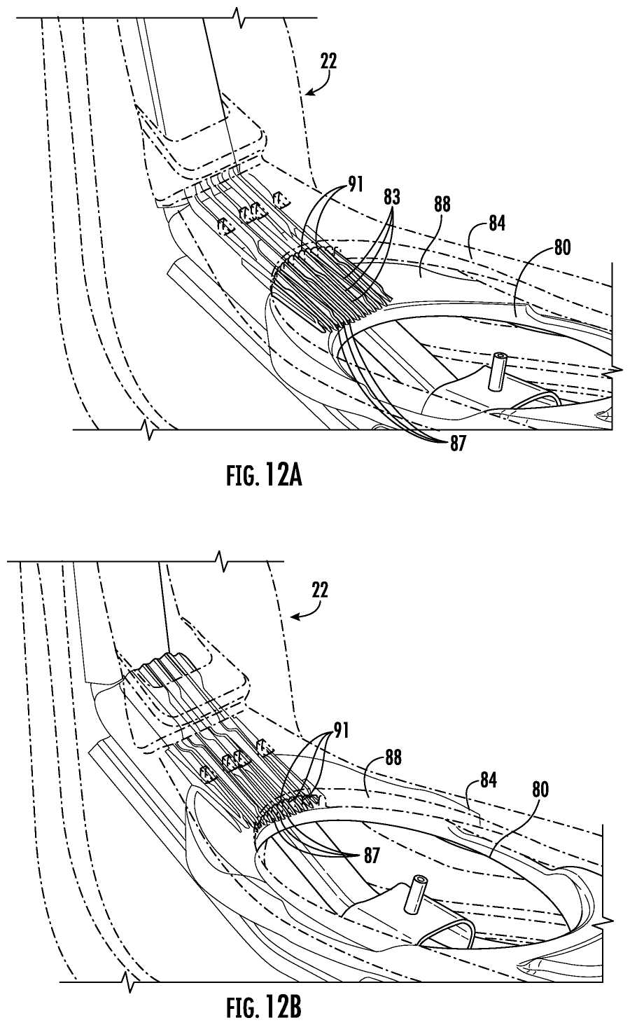

With reference to FIGS. 11A-12B, an alternative or additional connection between the seat receiving assembly 40 and the base body 22 is illustrated. As shown, at least one rib 83, such as a plurality of ribs for example, protrudes upwardly from the upper surface of the fin 88 of the support plate 80. The ribs 83 may but need not extend beyond the end 85 of the support plate 80. In addition, the configuration of the ribs 83 may be substantially identical or may vary. In the illustrated, non-limiting embodiment, the plurality of ribs 83 are spaced apart from one another to define a slot 87 between adjacent ribs 83. As best shown in FIG. 11B, an inner surface 89 of the base body 22, facing toward the fin 88 includes one or more projections 91 slidably receivable within the one or more slots 87 defined by the ribs 83. In embodiments including a plurality of projections 91, the projections 91 may be substantially identical, or may vary. Further, the projections 91 may be axially spaced over the inner surface 89 in one or more directions such that two or more projections 91 may be receivable within the same slot 87. However, in other embodiments, both the upper surface of the fin 88 and the corresponding inner surface 89 of the base body 22 may be substantially smooth. In such embodiments, the upper surface of the fin 88 may be separated from the inner surface 89 of the base body 22 by a gap or clearance such that the support plate 80 is freely movable with the incline member 42 relative to the base body 22.

With reference to FIGS. 12A and 12B, as the incline member 42, and therefore the support plate 80 and seat attachment 60, translate between the first position (FIG. 12A) and the second position (FIG. 12B), the at least one projection 91 remains arranged within a corresponding slot 87, thereby limiting lateral movement of the seat receiving assembly 40. In addition, this engagement between the at least one slot 87 and projection 91 allows the vehicle belt force to be transferred directly to the seat receiving assembly 40 by the base body 22.

Further, it should be appreciated that because the seat attachment 60 is coupled to the incline member 42 via the mounting post 92, the seat attachment 60 and a child seat affixed to the seat attachment 60 are movable with the incline member 42 relative to the support base 20.

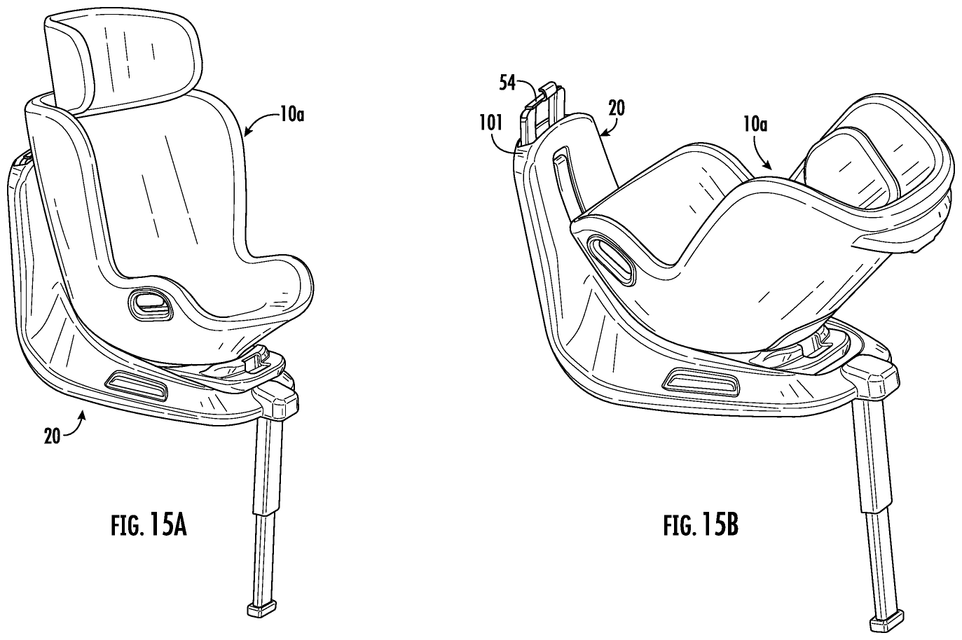

The incline member 42 is transformable between the first position (FIGS. 13A, 13B, 14A, and 14B) and the second position (FIGS. 15A, 15B, 16A, and 16B) regardless of the rotational position of the seat attachment 60 relative to the base body 22 and the incline member 42. For example, the incline member 42 may be movable when the seat attachment 60 is at any location of the 360 degrees of rotation of the seat attachment 60. Similarly, the seat attachment 60 may be rotatable about the axis X regardless of the position of the incline member 42 relative to the base body 22. As shown, either child seat 10a, 10b can be inclined when in both the first forward-facing configuration, the second rearward-facing configuration, and any position therebetween. Further, because the incline member 42 is located within the interior 44 of the base body 22 and is separate from the belt tensioner 35 and the belt receiving path, the incline member 42 is moveable between the first and second positions without impacting a position of the vehicle belt on the belt receiving path and without affecting the tension applied to the vehicle belt by the belt tensioner 35.

In the illustrated, non-limiting embodiment best shown in FIG. 9, the incline member 42 includes a plurality of incline retention members 112, for example in vertically overlapping arrangement with the lower portion 50 of the legs 46a, 46b, respectively. The ends 114 of the incline retention members 112 positioned closest to the mounting bracket 90 may have a contour complementary to the periphery of the collar 72 or flanges 74, 78. Although each incline retention member 112 is illustrated as a distinct component, embodiments where each of the ends 114 thereof cooperate or are coupled to define a ring that extends about a substantial entirety of the periphery of the collar or flanges 74, 78 is also within the scope of the disclosure.

As the incline member 42 is transformed from a first or reclined position to a second or inclined position, the ends 114 of the incline retention members 112 arranged at a first side of the collar 72 are configured to engage a portion of the flange 74, 78 of the seat attachment 60 to prevent transverse movement of the seat attachment 60. Similarly, as the incline member 42 is transformed from an inclined position to a reclined position, the ends 114 of the incline retention members 112 arranged at a second side of the collar 72 are configured to engage a portion of the flange 74, 78 of the seat attachment 60 to prevent transverse movement of the seat attachment 60. For example, in embodiments where the seat attachment 60 is arranged in one of a forward-facing configuration or a rearward-facing configuration, the incline retention members 112 are configured to engage the at least one flange 78 of the attachment member 64 to restrict unwanted movement of the seat attachment 60. However, embodiments where the one or more of the incline retention members 112 are alternatively or additionally configured to engage a flange 74 of the collar 72 when the seat attachment 60 is in one of a forward-facing configuration or a rearward facing configuration are also contemplated herein. It should also be appreciated that the incline retention members 112 may be configured to contact one or both flanges 74, 78 based on the relative position of the seat attachment 60.

Further, because the opening 82 of the support plate 80 is substantially identical in size to the diameter of the collar 72, in some embodiments, the movement of the seat attachment 60 resulting from movement of the incline member 42 may cause a similar movement of the support plate 80 relative to the base body 22. However, by forming the support plate 80 with dimensions greater than the opening 84 formed in the base body 22, the opening 84 remains covered regardless of the position of the support plate 80.

An incline locking mechanism is associated with the incline member 42 and is operable to selectively lock the incline member 42 in one of a plurality of configurations, including the first reclined configuration and the second inclined configuration. When the incline locking mechanism is engaged, movement of the incline member 42 relative to the support base 20 is restricted. It should be appreciated that the incline locking mechanism may be operable to lock the incline member 42 in only one of the reclined position and the inclined position. However, in other embodiments, the incline locking mechanism may be configured to lock the incline member 42 at any suitable position along the path of movement between the reclined position and the inclined position to achieve varying degrees of incline of the seat attachment 60.

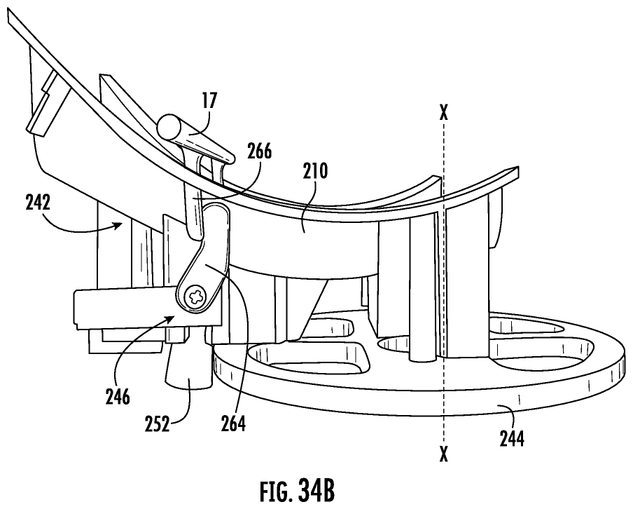

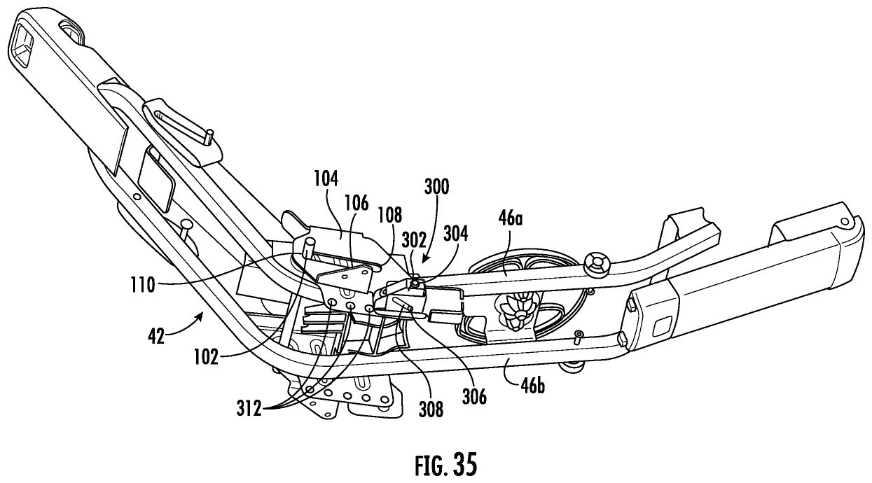

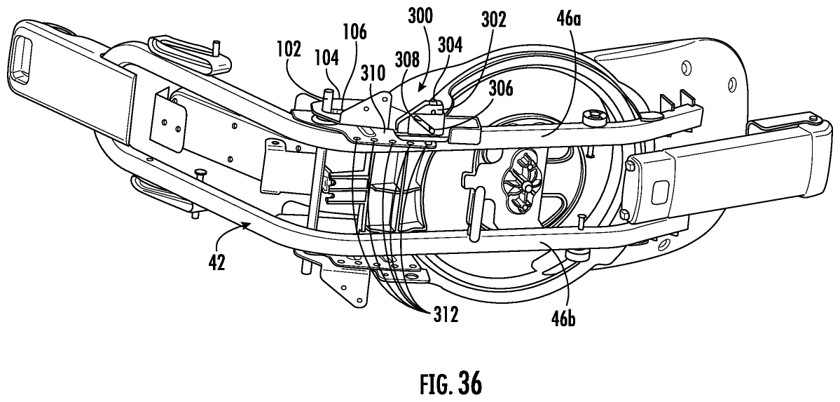

With reference now to FIGS. 35-37, an example of an incline locking mechanism 300 is illustrated. As shown, the incline locking mechanism 300 includes a housing 302, a locking pin 304 movable relative to the housing 302 between an engaged position and a disengaged position, and a recline member 306 operably coupled to the locking pin 304. The housing of the incline locking mechanism may be affixed to a portion of a movement bracket 104, such as at a location offset from the slot 106. The recline member 306 includes a post or pin arranged within an elongated slot 308 formed in the housing 302. In the illustrated, non-limiting embodiment, the slot 308 is arranged at an angle to the path of movement of the locking pin 304.

As shown, a locking bracket 310 may be arranged between the mounting bracket 104 and a surface of a leg 46a of the incline member 42. Accordingly, the pin 102 may be formed as part of the locking bracket 310, or alternatively, may also extend through an opening formed in the locking bracket 310. The locking bracket 310 has a plurality of locking openings 312 formed therein. It should be appreciated that the plurality of locking openings 312 includes a first locking opening associated with a fully reclined position and a second locking opening associated with a fully inclined position. The plurality of locking openings 312 may additionally include one or more openings disposed between the first and second locking openings associated with at least one intermediate position of the incline member 42.

The incline lock mechanism 300 is positioned such that the locking pin 304 is generally aligned or arranged within the plane containing the plurality of locking openings 312. Receipt of the locking pin 304 within one of the plurality of locking openings 312 restricts movement of the locking bracket 310, and therefore the incline member 42, relative to the mounting bracket 104 and the base body 22. As the pin 102 translates within the slot 106, the locking bracket 310 moves relative to the incline lock mechanism 300, causing different locking openings of the plurality of locking openings 312 to be sequentially aligned with the locking pin 304 over the path of inclined movement.

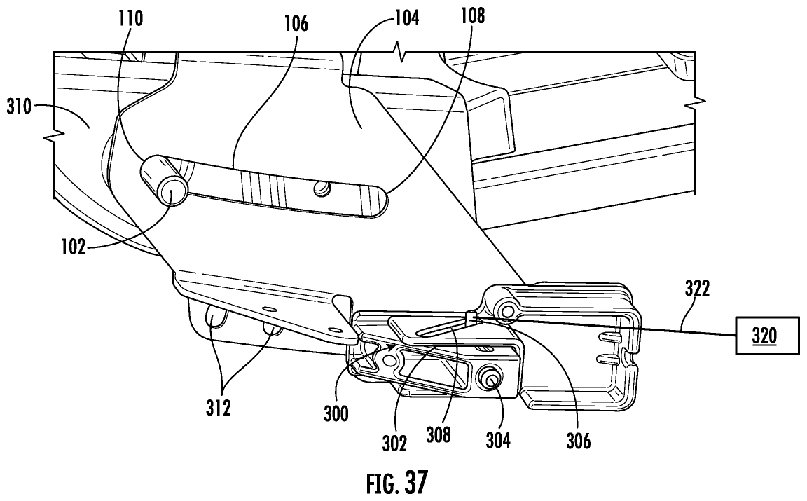

With reference to FIG. 37, an incline release actuator 320 is operable to selectively disengage the incline locking mechanism 300, thereby allowing movement of the incline member 42 relative to the support base 20. In an embodiment, the incline release actuator 320 is operable to disengage the locking pin 304 from one of the plurality of locking openings 312 formed in the locking bracket 310, thereby allowing movement of the locking bracket 310 coupled to the incline member 42 relative to the mounting bracket 104. In an embodiment, the incline release actuator 320 is operably coupled to the recline member 306 by a cable or tension member 322. In response to operation of the incline release actuator 320, the recline member 306 is configured to translate within the slot 308 formed in the housing 302. This movement of the recline member 306 causes the locking pin 304 to translate out of the plane of the locking bracket 310, thereby separating the locking pin 304 from a corresponding locking opening 312. It should be appreciated that the incline lock mechanism 300 and incline release actuator 320 illustrated and described herein are intended as an example only and that either a lock mechanism or release actuator having another suitable configuration is within the scope of the disclosure.

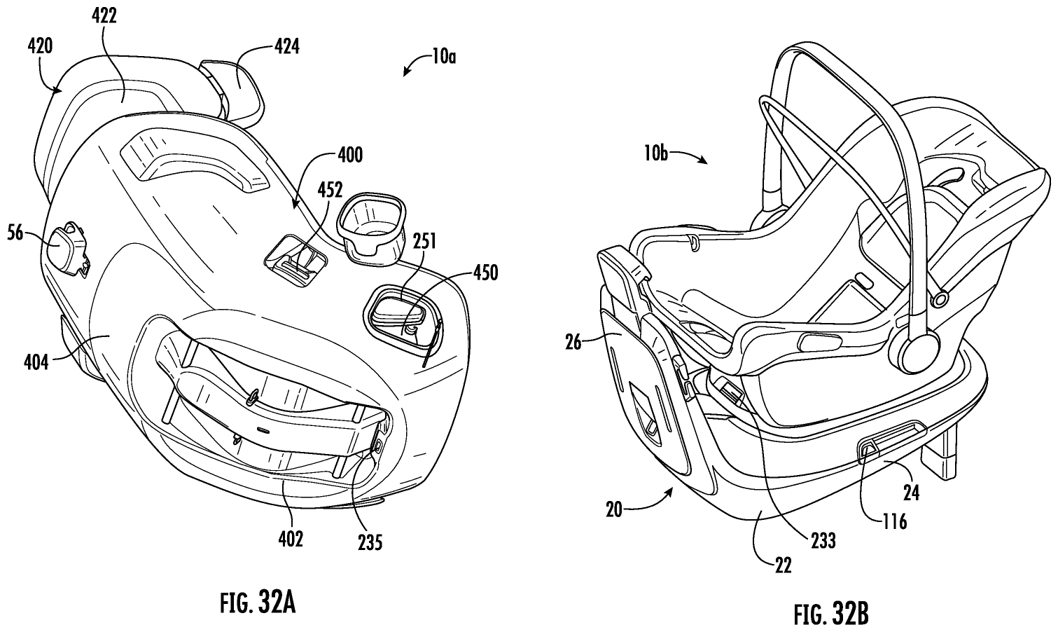

Although an input 116 associated with operation of the incline release actuator is illustrated as being arranged at the support plate 80, near the second end of the seat portion 24 of the base body 22 for example, in other embodiments, the input may be located at another location about the support base 20. For example, in the non-limiting embodiment of FIGS. 32B and 39A-39C, the input 116 associated with operation of the incline release actuator 320 is located at a side of the base body 22, accessible when both a first child seat 10a and a second child seat 10b is coupled to the seat attachment 60.

The support base 20 as described herein provides the benefit of being suitable for use with multiple interchangeable child seats, such that the same base may be used with different seats as a child grows. Further, the support base 20 allows the rotational configuration and the incline of each child seat to be adjusted relative to the base body 22 and the vehicle seat.

Embodiment 1: A support base for a child restraint system suitable for placement on a vehicle seat, the child restraint system including an infant child seat and a convertible child seat, the support base comprising a base body; and a seat receiving assembly comprising an incline member movably mounted to the base body, the incline member being movable along an incline path between a first position and a second position; and a seat attachment rotatably connected to the incline member, the seat attachment being rotatable relative to the incline member between a first rotational configuration and a second rotational configuration.

Embodiment 2. The support base of embodiment 1, wherein the seat attachment is configured to detachably connect to both the infant child seat and the convertible child seat.

Embodiment 3. The support base of embodiment 1, wherein the seat attachment is rotatable relative to the incline member at any position of the incline member relative to the incline path.

Embodiment 4. The support base of embodiment 1, wherein the support base further comprises a belt receiving path for a vehicle belt associated with the vehicle seat and an exterior surface of the base body.

Embodiment 5. The support base of embodiment 4, wherein the support base further comprises a belt tensioner mounted to the base body, the belt tensioner being movable to apply a tension to the vehicle belt.

Embodiment 6. The support base of embodiment 5, wherein the incline member is located remotely from the belt receiving path such that the tension applied to the vehicle belt by the belt tensioner is unaffected by movement of the incline member over the incline path.

Embodiment 7. The support base of embodiment 1, wherein the base body further comprises at least one elongated slot, the incline member being coupled to the at least one elongated slot, wherein the at least one elongated slot defines the incline path of the incline member between the first position and the second position.

Embodiment 8. The support base of embodiment 1, wherein the base body further comprises a seat portion and a back portion, the back portion being arranged at an angle relative to the seat portion.

Embodiment 9. The support base of embodiment 8, wherein the incline member further comprises a first leg and a second leg, each of the first leg and the second leg having an upper portion and a lower portion, the upper portions of the first leg and the second leg being connected by a connecting member.

Embodiment 10. The support base of embodiment 9, wherein the upper portion is arranged within the back portion and the lower portion is arranged within the seat portion.

Embodiment 11. The support base of embodiment 10, wherein an angle formed between the upper portion and the lower portion of the first leg and the second leg is equal to the angle formed between the seat portion and the back portion of the base body.

Embodiment 12. The support base of embodiment 1, wherein the incline member further comprises a base anchor member connectable to a seat anchor member of at least one of the infant child seat and the convertible child seat.

Embodiment 13. The support base of embodiment 1, wherein the first rotational configuration is a forward-facing position and the second rotational configuration is a rearward-facing position.

Embodiment 14. The support base of embodiment 1, wherein the seat attachment further comprises a support platform connectable to the infant child seat and the convertible child seat and an attachment member coupled to the support platform, the support platform being in axial overlapping arrangement with the attachment member.

Embodiment 15. The support base of embodiment 14, wherein the attachment member further comprises an opening and the incline member further comprises a mounting post, the mounting post being receivable within the opening to define an axis of rotation of the seat attachment.

Embodiment 16. The support base of embodiment 1, wherein the incline member is movable relative to the base body along the incline path.

Embodiment 17. A support base for a child restraint system suitable for placement on a vehicle seat, the child restraint system including a child seat, the support base comprising a base body, an incline member movably mounted to the base body, the incline member being movable along an incline path between a first position and a second position, and a seat attachment rotatably connected to the incline member, the seat attachment being rotatable relative to the incline member between a first rotational configuration and a second rotational configuration, the seat attachment being configured to detachably connect to the child seat, wherein the incline member can move between the first position and the second position when the seat attachment is in the first rotational configuration and the second rotational configuration.

Embodiment 18. The support base of embodiment 17, wherein the seat attachment is rotatable relative to the incline member at any position of the incline member relative to the incline path.

Embodiment 19. The support base of embodiment 17, wherein the incline member is movable along the incline path regardless at any rotational configuration of the seat attachment.

Embodiment 20. The support base of embodiment 17, wherein the support base further comprises a belt receiving path for a vehicle belt associated with the vehicle seat and an exterior surface of the base body.

Embodiment 21. The support base of embodiment 20, wherein the support base further comprises a belt tensioner mounted to the base body, the belt tensioner being movable to apply a tension to the vehicle belt.

Embodiment 22. The support base of embodiment 21, wherein the incline member is located remotely from the belt receiving path such that the tension applied to the vehicle belt by the belt tensioner is unaffected by movement of the incline member between the first position and the second position.

Embodiment 23. The support base of embodiment 17, wherein the base body further comprises at least one elongated slot, the incline member being coupled to the at least one elongated slot, wherein the at least one elongated slot defines the incline path of the incline member between the first position and the second position.

Embodiment 24. The support base of embodiment 17, wherein the inclined member is movably coupled to the base body via a first pinned connection and a second pinned connection.

Embodiment 25. The support base of embodiment 17, wherein the inclined member further comprises a roller, the roller being arranged within a track formed in the base body.

Embodiment 26. The support base of embodiment 17, wherein the base body further comprises a seat portion and a back portion, the back portion being arranged at an angle relative to the seat portion.

Embodiment 27. The support base of embodiment 26, wherein the incline member further comprises a first leg and a second leg, each of the first leg and the second leg having an upper portion and a lower portion, the upper portions of the first leg and the second leg being connected by a connecting member.

Embodiment 28. The support base of embodiment 27, wherein the upper portion is arranged within the back portion and the lower portion is arranged within the seat portion.

Embodiment 29. The support base of embodiment 27, wherein an angle formed between the upper portion and the lower portion of the first leg and the second leg is equal to the angle formed between the seat portion and the back portion of the base body.

Embodiment 30. The support base of embodiment 17, wherein the incline member further comprises a base anchor member connectable to a seat anchor member of the child seat.

Embodiment 31. The support base of embodiment 17, wherein the first rotational configuration is a forward-facing position and the second rotational configuration is a rearward facing position.

Embodiment 32. The support base of embodiment 17, wherein the seat attachment further comprises a support platform connectable to the child seat and an attachment member coupled to the support platform, the support platform being in axial overlapping arrangement with the attachment member.

Embodiment 33. The support base of embodiment 32, wherein the attachment member further comprises an opening and the incline member further comprises a mounting post, the mounting post being receivable within the opening to define an axis of rotation of the seat attachment.

Embodiment 34. The support base of embodiment 17, wherein the incline member is movable relative to the base body along the incline path.

Embodiment 35. A support base for a child restraint system, the support base being attachable to a vehicle seat by a vehicle belt, the support base comprising a base body having a top surface and a bottom surface, the bottom surface being positionable on the vehicle seat, an incline member movably mounted to the base body, the incline member being movable along an incline path between a first position and a second position, a belt receiving path for receiving the vehicle belt to secure the support base to the vehicle seat, the belt receiving path being at least partially defined by the top surface, wherein the incline member is movable between the first position and the second position without impacting a position of the vehicle belt on the belt receiving path.

Embodiment 36. The support base of embodiment 35, wherein the support base further comprises a belt tensioner, the belt receiving path extending between the belt tensioner and the top surface of the base body, wherein the belt tensioner is movable to apply a tension to the vehicle belt.

Embodiment 37. The support base of embodiment 35, wherein the base body further comprises at least one elongated slot, the incline member being coupled to the at least one elongated slot, wherein the at least one elongated slot defines the incline path of the incline member between the first position and the second position.

Embodiment 38. The support base of embodiment 35, wherein the base body further comprises a seat portion and a back portion, the back portion being arranged at an angle relative to the seat portion.

Embodiment 39. The support base of embodiment 38, wherein the incline member further comprises a first leg and a second leg, each of the first leg and the second leg having an upper portion and a lower portion, the upper portions of the first leg and the second leg being connected by a connecting member.

Embodiment 40. The support base of embodiment 39, wherein the upper portion is arranged within the back portion and the lower portion is arranged within the seat portion.

Embodiment 41. The support base of embodiment 39, wherein an angle formed between the upper portion and the lower portion of the first leg and the second leg is equal to the angle formed between the seat portion and the back portion of the base body.

Embodiment 42. The support base of embodiment 35, wherein the incline member is movable relative to the base body along the incline path.

Embodiment 43. The support base of embodiment 35, wherein the incline member is movable between the first position and the second position without impacting a tension in the vehicle belt on the belt receiving path.

Embodiment 44. A support base for a child restraint system, the child restraint system including a child seat having a seat portion and a back portion extending therefrom, the support base comprising a base body, an incline member movably connected to the base body, the incline member being movable along an incline path between a first position and a second position, a seat attachment connected to the incline member, the seat attachment being detachably connectable to the seat portion of the child seat, and a base anchor member fixedly connected to the incline member, the base anchor member being connectable with a seat anchor member of the child seat.

Embodiment 45. The support base of embodiment 44, wherein the seat anchor member is arranged at the back portion of the child seat.

Embodiment 46. The support base of embodiment 44, wherein the seat attachment is rotatably connected to the incline member, the seat attachment being rotatable between a first rotational configuration and a second rotational configuration.

Embodiment 47. The support base of embodiment 46, wherein the base anchor member is connectable to the seat anchor member when the seat attachment is in the first rotational configuration.

Embodiment 48. The support base of embodiment 46, wherein the base anchor member is not connectable to the seat anchor member when the seat attachment is in the second rotational configuration.

Embodiment 49. The support base of embodiment 46, wherein the base anchor member is connectable to the seat anchor member when the child seat is in a forward-facing configuration.

Embodiment 50. The support base of embodiment 44, wherein the incline member is movable relative to the base body along the incline path.

Embodiment 51. The support base of embodiment 44, further comprising a tether assembly including a tether support arranged within an interior of the base body and a tether strap extendable through an opening formed in the base body, the tether strap being positionable in contact with the tether support when extended through the opening.

Embodiment 52. The support base of embodiment 51, wherein the opening is arranged adjacent to the base anchor member.

Embodiment 53. A support base for a child restraint system suitable for placement on a vehicle seat, the child restraint system including a first child seat and a second child seat, the support base comprising a base body, and a seat attachment connected to the base body, the seat attachment being rotatable about an axis relative to the base body between a first rotational configuration and a second rotational configuration, wherein allowable rotation between the first rotational configuration and the second rotational configuration varies based on which of the first child seat and the second child seat is connected to the seat attachment.

Embodiment 54. The support base of embodiment 53, wherein the seat attachment is rotatable 180 degrees between the first rotational configuration and the second rotational configuration when the first child seat is connected to the seat attachment.

Embodiment 55. The support base of embodiment 53, wherein the first child seat is a convertible child seat.

Embodiment 56. The support base of embodiment 53, wherein the seat attachment is rotatable less than 180 degrees between the first rotational configuration and the second rotational configuration when the second child seat is connected to the seat attachment.

Embodiment 57. The support base of embodiment 53, wherein the seat attachment is rotatable 90 degrees between the first rotational configuration and the second rotational configuration when the second child seat is connected to the seat attachment.

Embodiment 58. The support base of embodiment 53, wherein the second child seat is an infant child seat.

Embodiment 59. A support base for a child restraint system suitable for placement on a vehicle seat, the support base comprising a base body, an incline member movably mounted to the base body, and a seat attachment coupled to the incline member, wherein the incline member and the seat attachment are movable along a path of movement relative to the base body between a first position and a second position.

Embodiment 60. The support base of embodiment 59, wherein the seat attachment is rotatably connected to the incline member, the seat attachment being rotatable relative to the incline member between a first rotational configuration and a second rotational configuration.

Embodiment 61. The support base of embodiment 60, wherein the first rotational configuration is a forward-facing position and the second rotational configuration is a rearward facing position.

Embodiment 62. The support base of embodiment 60, wherein the seat attachment is rotatable relative to the incline member at any position of the incline member relative to the path of movement.

Embodiment 63. The support base of embodiment 59, wherein the support base further comprises a belt receiving path for a vehicle belt associated with the vehicle seat and an exterior surface of the base body.

Embodiment 64. The support base of embodiment 63, wherein the support base further comprises a belt tensioner mounted to the base body, the belt tensioner being movable to apply a tension to the vehicle belt.

Embodiment 65. The support base of embodiment 64, wherein the incline member is located remotely from the belt receiving path such that the tension applied to the vehicle belt by the belt tensioner is unaffected by movement of the incline member over the path of movement.

Embodiment 66. The support base of embodiment 59, wherein the base body further comprises at least one elongated slot, the incline member being coupled to the at least one elongated slot, wherein the at least one elongated slot defines the path of movement of the incline member between the first position and the second position.

Embodiment 67. The support base of embodiment 59, wherein the base body further comprises a seat portion and a back portion, the back portion being arranged at an angle relative to the seat portion.

Embodiment 68. The support base of embodiment 67, wherein the incline member further comprises a first leg and a second leg, each of the first leg and the second leg having an upper portion and a lower portion, the upper portions of the first leg and the second leg being connected by a connecting member.

Embodiment 69. The support base of embodiment 68, wherein the upper portion is arranged within the back portion and the lower portion is arranged within the seat portion.

Embodiment 70. The support base of embodiment 69, wherein an angle formed between the upper portion and the lower portion of the first leg and the second leg is equal to the angle formed between the seat portion and the back portion of the base body.

Embodiment 71. The support base of embodiment 59, wherein the incline member further comprises a base anchor member connectable to a seat anchor member of a child seat of the child restraint system.

Embodiment 72. A child seat for a child seat system, the child seat system including a seat base for placement on a vehicle seat, the child seat comprising a seat portion connectable to the seat base, a back portion extending from the seat portion, and a seat anchor member attached to the back portion, the seat anchor member being connectable to a base anchor member of the seat base, wherein the child seat is rotatable relative to the seat base between a first rotational configuration and a second rotational configuration, wherein in the first rotational configuration, the seat anchor member is connected to the base anchor member, and in the second rotational configuration, the seat anchor member is spaced from the base anchor member, wherein the seat anchor member is configured to self-align with the base anchor member such that as the child seat rotates from the second rotational configuration to the first rotational configuration, the seat anchor member aligns with the base anchor member.

Embodiment 73. The child seat of embodiment 72, wherein the child seat is movable relative to the seat base between a first inclination position and a second inclination position, and wherein as the child seat transitions between the first inclination position and the second inclination position, a connection between the seat anchor member and the base anchor member moves relative to either one of the child seat and the seat base.

Embodiment 74. The child seat of embodiment 72, further comprising a headrest arranged at the back portion, the headrest including a main body and a side impact portion removably coupled to the main body.

Embodiment 75. The child seat of embodiment 72, further comprising a seat frame disposed within the seat portion and a harness assembly including a crotch strap, the crotch strap being coupled to the seat frame via an anchor pin.

Embodiment 76. The child seat of embodiment 72, further comprising a harness assembly including a crotch strap; and a slider movably mounted within the seat portion, the crotch strap being coupled to the slider, wherein movement of the slider relative to the seat portion tightens the crotch strap.

Embodiment 77. A support base for a child restraint system including a child seat, the support base comprising a base body, a seat attachment rotatably coupled to the base body, the seat attachment being connectable to the child seat; and a lock mechanism comprising a lock member transitionable between a locked position, in which the lock member engages the seat attachment to prevent rotation of the seat attachment relative to the base body, and an unlocked position, in which the lock member is disengaged from the seat attachment, a first actuator operably coupled to the lock member to selectively transition the lock member between the locked position and the unlocked position, and a second actuator operably coupled to the lock member to selectively transition the lock member between the locked position and the unlocked position.

Embodiment 78. The support base of embodiment 77, wherein the first actuator and the second actuator are independently operable to transition the lock member between the locked position to the unlocked position.

Embodiment 79. The support base of embodiment 77, wherein the first actuator is arranged at the base body and the second actuator is located about the child seat.

Embodiment 80. The support base of embodiment 77, wherein the first actuator is operable to pull the lock member to transition the lock member from the locked position to the unlocked position and the second actuator is operable to push the lock member to transition the lock member from the locked position to the unlocked position.

Embodiment 81. The support base of embodiment 77, further comprising a biasing mechanism operably coupled to the lock member, wherein a biasing force of the biasing mechanism biases the lock member to the locked position.

Embodiment 82. The support base of embodiment 77, wherein the seat attachment further comprises a support platform including an annular collar, the lock member engaging a portion of the annular collar to prevent rotation of the seat attachment relative to the base body.

Embodiment 83. The support base of embodiment 78, wherein the annular collar further comprises at least one opening formed therein, the lock member being receivable within the at least one opening in the locked position.

Embodiment 84. The support base of embodiment 83, wherein the at least one opening further comprises a first opening arranged at a position about the annular collar associated with the child seat in a forward-facing configuration and a second opening arranged at another position about the annular collar associated with the child seat in a rearward-facing configuration.

Embodiment 85. A support base for a child restraint system suitable for placement on a vehicle seat, the child restraint system including a first child seat and a second child seat, the support base comprising a base body, a seat attachment connectable to the first child seat and to the second child seat, the seat attachment being rotatable relative to the base body between a first rotational configuration and a second rotational configuration, and a spin lock-out mechanism operably connected between the base body and the seat attachment, the spin lock-out mechanism comprising a first spin lock member fixedly connected to the base body, and a second spin lock member connected to the seat attachment, the second spin lock member being rotatable relative to the first spin lock member, wherein the second spin lock member is transformable between a lockable configuration and a free configuration, the second spin lock member being in the free configuration when the first child seat is connected to the seat attachment and the second spin lock member being in the lockable configuration when the second child seat is connected to the seat attachment.

Embodiment 86. The support base of embodiment 85, wherein the first child seat is a convertible child seat and the second child seat is an infant child seat.

Embodiment 87. The support base of embodiment 86, wherein the convertible child seat is a toddler seat.

Embodiment 88. The support base of embodiment 85, wherein in the free configuration, the second spin lock member is rotatable 360 degrees.

Embodiment 89. The support base of embodiment 85, wherein in the lockable configuration, the second spin lock member is rotatable about an axis less than 360 degrees.

Embodiment 90. The support base of embodiment 85, wherein in the free configuration, the second spin lock member is rotatable relative to the first spin lock member between the first rotational configuration and the second rotational configuration, and in the lockable configuration, the second spin lock member is restricted from rotating to the first rotational configuration.

Embodiment 91. The support base of embodiment 90, wherein the first rotational configuration is a forward-facing position and the second rotational configuration is a rearward-facing position.

Embodiment 92. The support base of embodiment 85, wherein in the lockable configuration, a portion of the first spin lock member is arranged within a path of rotation of the second spin lock member.

Embodiment 93. The support base of embodiment 92, wherein the first spin lock member includes a protrusion and during rotation of the second spin lock member in the lockable configuration, the second spin lock member engages the protrusion.

Embodiment 94. The support base of embodiment 93, wherein in the free configuration, the path of rotation of the second spin lock member is arranged radially outward of the protrusion.

Embodiment 95. The support base of embodiment 85, wherein the second spin lock member is rotatable about an axis between the free configuration and the lockable configuration.

Embodiment 96. The support base of embodiment 85, wherein the second spin lock member further comprises a shaft mounted to the seat attachment, an engagement member affixed to the shaft, and a biasing mechanism operably coupled to the engagement member, wherein a biasing force of the biasing mechanism biases the second spin lock member to the lockable configuration.

Embodiment 97. The support base of embodiment 96, wherein the shaft is rotatable about a shaft axis relative to the seat attachment between the free configuration and the lockable configuration.

Embodiment 98. The support base of embodiment 96, wherein an intermediate shaft of the second child seat connectable to the seat attachment is operable to oppose the biasing force of the biasing mechanism.

Embodiment 99. The support base of embodiment 85, further comprising a lock member transitionable between a locked position and an unlocked position, the seat attachment being restricted from rotating relative to the base body when the lock member is in the locked position.

Embodiment 100. The support base of embodiment 99, wherein the first spin lock member further comprises at least one locking feature, the lock member being engaged with the at least one locking feature in the locked position and the lock member being disengaged from the at least one locking feature in the unlocked position.

Embodiment 101. The support base of embodiment 99, further comprising an actuator operably coupled to the lock member to transform the locked member from the locked position to the unlocked position, wherein the actuator is mounted to the seat attachment and is rotatable with the seat attachment relative to the base body.

Embodiment 102. A support base for a child restraint system installable on a vehicle seat, the child restraint system including a child seat, the support base comprising a base body, a seat attachment connectable to the child seat, the seat attachment being rotatable relative to the base body between a first rotational configuration and a second rotational configuration, and a removal lock member connected to the seat attachment, the removal lock member being movable between a locked position and an unlocked position, the removal lock member being arrangeable in the locked position when the seat attachment having the child seat connected thereto is in the first rotational configuration relative to the base body and the removal lock member being arrangeable in the unlocked position when the seat attachment having the child seat connected thereto is in the second rotational configuration relative to the base body.

Embodiment 103. The support base of embodiment 102, wherein the child seat is separable from the seat attachment when the removal lock member is in the unlocked position and the child seat is inseparable from the seat attachment when the removal lock member is in the locked position.

Embodiment 104. The support base of embodiment 102, wherein the first rotational configuration is a forward-facing configuration.

Embodiment 105. The support base of embodiment 102, wherein the removal lock member is rotatable between the unlocked position and the locked position.

Embodiment 106. The support base of embodiment 105, wherein the removal lock member is fixedly mounted to a shaft, the shaft being rotatable about a shaft axis.

Embodiment 107. The support base of embodiment 106, wherein the removal lock member further comprises an engagement feature, the engagement feature being engaged with the child seat when the removal lock member is in the locked position.

Embodiment 108. The support base of embodiment 107, wherein the child seat reaches the second rotational configuration when the child seat has rotated a distance from the first rotational configuration such that the engagement feature is disengaged with the child seat.

Embodiment 109. The support base of embodiment 107, wherein the engagement feature is a hook.

Embodiment 110. The support base of embodiment 107, wherein the child seat is a toddler seat.

Embodiment 111. The support base of embodiment 107, wherein the child seat further comprises an intermediate shaft engageable by the engagement feature when the removal lock member is in the locked position.

Embodiment 112. A support base for a child restraint system including a child seat, the support base comprising a base body, a seat attachment rotatably coupled to the base body, the seat attachment being connectable to the child seat, a spin lock-out mechanism affixed to the base body, the spin lock-out mechanism including at least one locking feature, and a lock mechanism comprising a lock member transitionable between a locked position in which the seat attachment is restricted from rotating relative to the base body and an unlocked position in which the seat attachment is rotatable relative to the base body, wherein the lock member is engaged with the at least one locking feature in the locked position and the lock member is disengaged from the at least one locking feature in the unlocked position.

Embodiment 113. The support base of embodiment 112, wherein the lock member is mounted to the seat attachment.

Embodiment 114. The support base of embodiment 112, further comprising an actuator operably coupled to the lock member to transform the locked member from the locked position to the unlocked position, the actuator being mounted to the seat attachment and is rotatable with the seat attachment relative to the base body.

The term “about” is intended to include the degree of error associated with measurement of the particular quantity based upon the equipment available at the time of filing the application. As used herein, the term “substantially” and derivatives thereof, and words of similar import, when used to describe a size, shape, orientation, distance, spatial relationship, or other parameter includes the stated size, shape, orientation, distance, spatial relationship, or other parameter, and can also include a range up to 10% more and up to 10% less than the stated parameter, including 5% more and 5% less, including 3% more and 3% less, including 1% more and 1% less.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made, and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

1. A support base for a child restraint system suitable for placement on a vehicle seat, the child restraint system including an infant child seat and a convertible child seat, the support base comprising:
a base body; and
a seat receiving assembly comprising:
an incline member movably mounted to said base body, said incline member being movable along an incline path between a first position and a second position; and
a seat attachment rotatably connected to said incline member, said seat attachment being rotatable relative to said incline member between a first rotational configuration and a second rotational configuration.

2. The support base of claim 1, wherein said seat attachment is configured to detachably connect to both the infant child seat and the convertible child seat.

3. The support base of claim 1, wherein said seat attachment is rotatable relative to said incline member at any position of said incline member relative to said incline path.

4. The support base of claim 1, wherein said support base further comprises:
a belt receiving path for a vehicle belt associated with the vehicle seat and an exterior surface of said base body.

5. The support base of claim 4, wherein said support base further comprises a belt tensioner mounted to said base body, said belt tensioner being movable to apply a tension to the vehicle belt.

6. The support base of claim 5, wherein said incline member is located remotely from said belt receiving path such that said tension applied to the vehicle belt by said belt tensioner is unaffected by movement of said incline member over said incline path.

7. The support base of claim 1, wherein said base body further comprises at least one elongated slot, said incline member being coupled to said at least one elongated slot, wherein said at least one elongated slot defines said incline path of said incline member between said first position and said second position.

8. The support base of claim 1, wherein said base body further comprises a seat portion and a back portion, said back portion being arranged at an angle relative to said seat portion.

9. The support base of claim 8, wherein said incline member further comprises a first leg and a second leg, each of said first leg and said second leg having an upper portion and a lower portion, said upper portions of said first leg and said second leg being connected by a connecting member.

10. The support base of claim 9, wherein said upper portion is arranged within said back portion and said lower portion is arranged within said seat portion.

11. The support base of claim 10, wherein an angle formed between said upper portion and said lower portion of said first leg and said second leg is equal to said angle formed between said seat portion and said back portion of said base body.

12. The support base of claim 1, wherein said incline member further comprises a base anchor member connectable to a seat anchor member of at least one of the infant child seat and the convertible child seat.

13. The support base of claim 1, wherein said first rotational configuration is a forward-facing position and said second rotational configuration is a rearward-facing position.

14. The support base of claim 1, wherein said seat attachment further comprises:
a support platform connectable to the infant child seat and the convertible child seat; and
an attachment member coupled to said support platform, said support platform being in axial overlapping arrangement with said attachment member.

15. The support base of claim 14, wherein said attachment member further comprises an opening and said incline member further comprises a mounting post, said mounting post being receivable within said opening to define an axis of rotation of said seat attachment.

16. The support base of claim 1, wherein said incline member is movable relative to said base body along said incline path.

17. A support base for a child restraint system suitable for placement on a vehicle seat, the child restraint system including a child seat, the support base comprising:
a base body;
an incline member movably mounted to said base body, said incline member being movable along an incline path between a first position and a second position; and
a seat attachment rotatably connected to said incline member, said seat attachment being rotatable relative to said incline member between a first rotational configuration and a second rotational configuration, said seat attachment being configured to detachably connect to the child seat;
wherein said incline member can move between said first position and said second position to affect a position of the seat attachment relative to the base body when said seat attachment is in said first rotational configuration and said second rotational configuration.

18. The support base of claim 17, wherein said seat attachment is rotatable relative to said incline member at any position of said incline member relative to said incline path.

19. The support base of claim 17, wherein said incline member is movable along said incline path regardless at any rotational configuration of said seat attachment.

20. The support base of claim 17, wherein said support base further comprises:
a belt receiving path for a vehicle belt associated with the vehicle seat and an exterior surface of said base body.

21. The support base of claim 20, wherein said support base further comprises a belt tensioner mounted to said base body, said belt tensioner being movable to apply a tension to the vehicle belt.

22. The support base of claim 21, wherein said incline member is located remotely from said belt receiving path such that said tension applied to the vehicle belt by said belt tensioner is unaffected by movement of said incline member between said first position and said second position.

23. The support base of claim 17, wherein said base body further comprises at least one elongated slot, said incline member being coupled to said at least one elongated slot, wherein said at least one elongated slot defines said incline path of said incline member between said first position and said second position.

24. The support base of claim 17, wherein said inclined member is movably coupled to said base body via a first pinned connection and a second pinned connection.

25. The support base of claim 17, wherein said inclined member further comprises a roller, said roller being arranged within a track formed in said base body.

26. The support base of claim 17, wherein said base body further comprises a seat portion and a back portion, said back portion being arranged at an angle relative to said seat portion.

27. The support base of claim 26, wherein said incline member further comprises a first leg and a second leg, each of said first leg and said second leg having an upper portion and a lower portion, said upper portions of said first leg and said second leg being connected by a connecting member.

28. The support base of claim 27, wherein said upper portion is arranged within said back portion and said lower portion is arranged within said seat portion.

29. The support base of claim 27, wherein an angle formed between said upper portion and said lower portion of said first leg and said second leg is equal to said angle formed between said seat portion and said back portion of said base body.

30. The support base of claim 17, wherein said incline member further comprises a base anchor member connectable to a seat anchor member of the child seat.

31. The support base of claim 17, wherein said first rotational configuration is a forward-facing position and said second rotational configuration is a rearward facing position.

32. The support base of claim 17, wherein said seat attachment further comprises:
a support platform connectable to the child seat; and
an attachment member coupled to said support platform, said support platform being in axial overlapping arrangement with said attachment member.

33. The support base of claim 32, wherein said attachment member further comprises an opening and said incline member further comprises a mounting post, said mounting post being receivable within said opening to define an axis of rotation of said seat attachment.

34. The support base of claim 17, wherein said incline member is movable relative to said base body along said incline path.

35. A support base for a child restraint system, the support base being attachable to a vehicle seat by a vehicle belt, the support base comprising:
a base body having a top surface and a bottom surface, said bottom surface being positionable on the vehicle seat;
an incline member movably mounted to said base body, said incline member being movable along an incline path between a first position and a second position;
a belt receiving path for receiving the vehicle belt to secure said support base to the vehicle seat, said belt receiving path being at least partially defined by said top surface, wherein said incline member is movable between said first position and said second position without impacting a position of the vehicle belt on said belt receiving path.

36. The support base of claim 35, wherein said support base further comprises a belt tensioner, said belt receiving path extending between said belt tensioner and said top surface of said base body, wherein said belt tensioner is movable to apply a tension to the vehicle belt.

37. The support base of claim 35, wherein said base body further comprises at least one elongated slot, said incline member being coupled to said at least one elongated slot, wherein said at least one elongated slot defines said incline path of said incline member between said first position and said second position.

38. The support base of claim 35, wherein said base body further comprises a seat portion and a back portion, said back portion being arranged at an angle relative to said seat portion.

39. The support base of claim 38, wherein said incline member further comprises a first leg and a second leg, each of said first leg and said second leg having an upper portion and a lower portion, said upper portions of said first leg and said second leg being connected by a connecting member.

40. The support base of claim 39, wherein said upper portion is arranged within said back portion and said lower portion is arranged within said seat portion.

41. The support base of claim 39, wherein an angle formed between said upper portion and said lower portion of said first leg and said second leg is equal to said angle formed between said seat portion and said back portion of said base body.

42. The support base of claim 35, wherein said incline member is movable relative to said base body along said incline path.

43. The support base of claim 35, wherein said incline member is movable between said first position and said second position without impacting a tension in the vehicle belt on said belt receiving path.
